(19) United States
(12) Patent Application Publication
(10) Pub. No.: US 2022/0365260 A1
(43) Pub. Date: Nov. 17, 2022

(54) RETROREFLECTIVE ARTICLE COMPRISING DISCONTINUOUS BINDER-BORNE REFLECTIVE LAYERS

(71) Applicant: 3M INNOVATIVE PROPERTIES COMPANY, St. Paul, MN (US)

(72) Inventors: Kui Chen-Ho, Woodbury, MN (US); Graham M. Clarke, Woodbury, MN (US); Kevin W. Gotrik, Hudson, WI (US); Michael A. McCoy, St. Paul, MN (US); Christopher A. Merton, St. Louis Park, MN (US); Aaron M. Nash, Columbia Heights, MN (US); Shri Niwas, Maple Grove, MN (US); Anthony F. Schultz, Forest Lake, MN (US); Carla S. Thomas, Woodbury, MN (US); Tien Yi T.H. Whiting, St. Paul, MN (US); Ying Xia, Woodbury, MN (US); Scott J. Jones, Woodbury, MN (US)

(21) Appl. No.: 17/764,281

(22) PCT Filed: Sep. 29, 2020
(86) PCT No.: PCT/IB2020/059115

§ 371 Date: Mar. 28, 2022

Related U.S. Application Data
(60) Provisional application No. 62/909,986, filed on Oct. 3, 2019.

(51) Int. Cl. G02B 5/128; G02B 1/111; G02B 1/12

(52) U.S. Cl. CPC G02B 5/128; G02B 1/111; G02B 1/12

(57) ABSTRACT

A retroreflective article including a binder layer and a plurality of retroreflective elements. Each retroreflective element includes a transparent microsphere partially embedded in the binder layer and a discontinuous binder-borne reflective layer that is provided by a portion of a fractured binder-borne reflective sheet.

### BACKGROUND

Retroreflective materials have been developed for a variety of applications. Such materials are often used e.g. as high visibility trim materials in clothing to increase the visibility of the wearer. For example, such materials are often added to garments that are worn by firefighters, rescue personnel, road workers, and the like.

### SUMMARY

In broad summary, herein is disclosed a retroreflective article comprising a binder layer and a plurality of retroreflective elements. Each retroreflective element comprises a transparent microsphere partially embedded in the binder layer. At least some of the retroreflective elements comprise a discontinuous binder-borne reflective layer that is provided by a portion of a fractured binder-borne reflective sheet. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a side schematic cross sectional view of an exemplary retroreflective article comprising discontinuous binder-borne reflective layers provided by portions of a fractured binder-borne reflective sheet.

FIG. 2 is a side schematic view of an exemplary process for making a retroreflective article, in which process a binder-borne reflective sheet is fractured to provide discontinuous binder-borne reflective layers.

FIG. 3 is a back-scattering scanning electron microscope 500× photograph of an exemplary Working Example retroreflective article comprising discontinuous binder-borne reflective layers provided by portions of a fractured binder-borne reflective sheet.

FIG. 4 is an isolated magnified side schematic cross sectional view of a portion of a transparent microsphere, a binder layer, and an exemplary discontinuous binder-borne reflective layer.

FIG. 5 is a side schematic cross sectional view of another exemplary retroreflective article, comprising discontinuous binder-borne reflective layers and also comprising at least one transparent-microsphere-borne reflective layer.

FIG. 6 is a side schematic cross sectional view of an exemplary transfer article comprising an exemplary retroreflective article, with the transfer article shown coupled to a substrate.

Like reference numbers in the various figures indicate like elements. Some elements may be present in identical or equivalent multiples; in such cases only one or more representative elements may be designated by a reference number but it will be understood that such reference numbers apply to all such identical elements. All non-photographic figures and drawings in this document are not to scale and are chosen for the purpose of illustrating different embodiments of the invention. The dimensions of the various components are depicted in illustrative terms only, and no relationship between the dimensions, relative curvatures, etc. of the various components should be inferred from the drawings. In particular, the thicknesses of reflective layers in proportion to certain other items are exaggerated for ease of illustration.

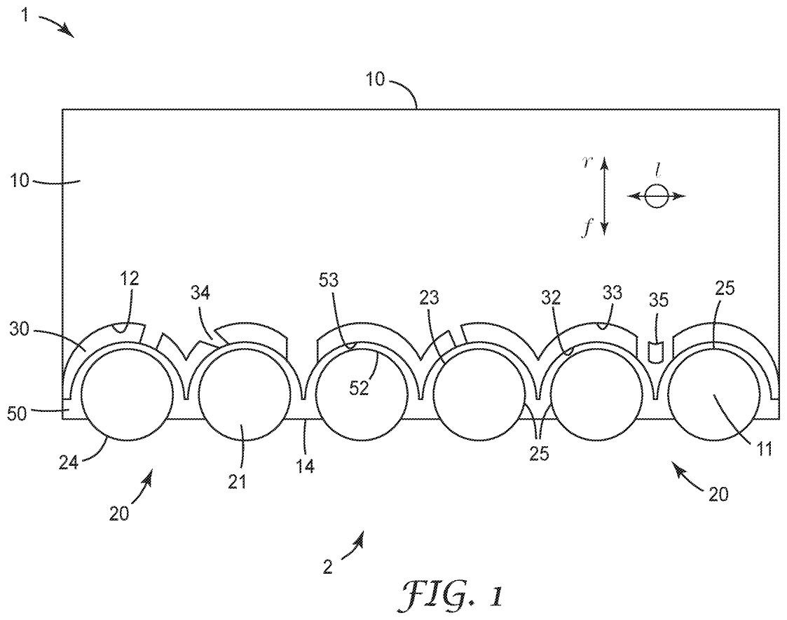

As used herein, terms such as “front”, “forward”, and the like, refer to the side from which a retroreflective article is to be viewed. Terms such as “rear”, “rearward”, and the like, refer to an opposing side, e.g. a side that is to be coupled to a garment. The term “lateral” refers to any direction that is perpendicular to the front-rear direction of the article, and includes directions along both the length and the breadth of the article. The front-rear direction (f-r), and exemplary lateral directions (l) of an exemplary article are indicated in FIG. 1. Even for specific items and components (e.g. binder layers and temporary carrier layers) that are used to form a retroreflective article, this front-rear terminology is with regard to the article as a whole rather than to the specific item.

Terms such as disposed, on, upon, atop, between, behind, adjacent, contact, proximate, and the like, do not require that a first entity (e.g. a layer) must necessarily be in direct contact with a second entity (e.g. a second layer) that the first entity is e.g. disposed on, behind, adjacent, or in contact with. Rather, such terminology is used for convenience of description and allows for the presence of an additional entity (e.g. a layer such as a bonding layer) or entities therebetween, as will be clear from the discussions herein.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). The term “substantially”, unless otherwise specifically defined, means to a high degree of approximation (e.g., within +/−10% for quantifiable properties). The term “essentially” means to a very high degree of approximation (e.g., within plus or minus 2% for quantifiable properties); it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter. All averages referred to herein are number-average unless otherwise specified.

### DETAILED DESCRIPTION

FIG. 1 illustrates a retroreflective article 1 in exemplary embodiment. As shown in FIG. 1, article 1 comprises a binder layer 10 that comprises a plurality of retroreflective elements 20 spaced over the length and breadth of a front side of binder layer 10. Each retroreflective element comprises a transparent microsphere 21 that is partially embedded in binder layer 10 so that the microspheres 21 are partially exposed and define a front (viewing) side 2 of the article. Binder layer 10 supports and retains transparent microspheres 21, and provides retroreflective article 1 with sufficient mechanical integrity to be processed and handled and to perform its desired functions (e.g. when attached to a garment).

Each transparent microsphere 21 has an embedded area 25 that is seated in a receiving cavity 11 of binder layer 10, and an exposed area 24 that is protrudes forwardly of major front surface 14 of article 1. In some embodiments, the exposed areas 24 of microspheres 21 of article 1 are exposed to an ambient atmosphere (e.g., air) in the final article as-used, rather than being e.g. covered with any kind of cover layer or the like. Such an article will be termed an exposed-lens retroreflective article.

Each retroreflective element 20 will comprise a reflective layer 30 disposed between the transparent microsphere 21 of the retroreflective element and the binder layer 10. The microspheres 21 and the reflective layers 30 collectively return a substantial quantity of incident light towards a source of light that impinges on front side 2 of article 1. That is, light that encounters the retroreflective article's front side 2 passes into and through microspheres 21 and is reflected by reflective layers 30 to again reenter the microspheres 21 such that the light is steered to return toward the light source.

Discontinuous Binder-Borne Reflective Layers

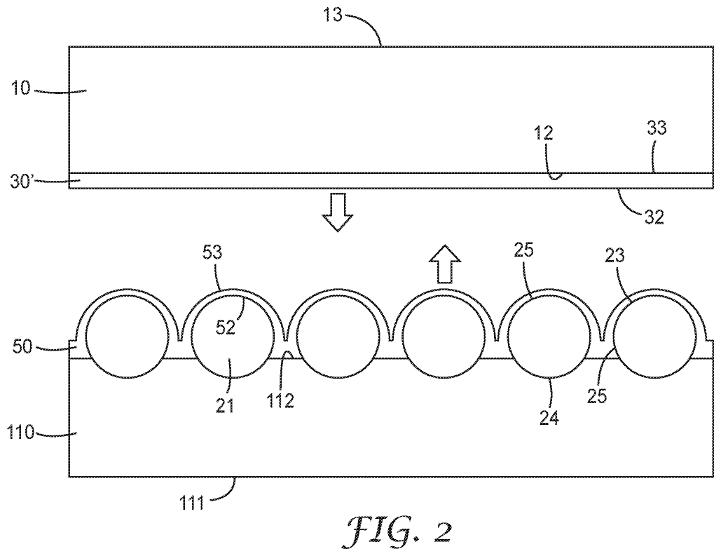

A retroreflective article 1 as disclosed herein will include at least some retroreflective elements 20 in which the reflective layer 30 of the retroreflective element 20 is a discontinuous binder-borne reflective layer, as illustrated in generic representation in FIG. 1. As defined herein, a “binder-borne” reflective layer 30 is a reflective layer obtained by providing a pre-made binder layer 10 bearing a pre-made reflective sheet 30′ on a front side thereof, and bringing the reflective-sheet-bearing side of the pre-made binder layer into contact with a set of transparent microspheres so that the reflective sheet 30′ fractures and the transparent microspheres are bonded, directly or indirectly, to the binder layer. This process is illustrated in idealized, generic representation in FIG. 2.

Such an operation will provide a set of retroreflective elements 20, each element 20 comprising a transparent microsphere 21 and a discontinuous binder-borne reflective layer 30 that is provided by a portion of a fractured binder-borne reflective sheet 30′. For clarity in the discussions herein, the term “layer” and the reference number 30 are used to denote the individual, discontinuous reflective layers of the individual retroreflective elements 20 and the term “sheet” and the reference number 30′ are used to denote the reflective sheet from which the individual reflective layers 30 were obtained by the fracturing of the reflective sheet 30′.

The present arrangements differ from conventional approaches in which a flowable binder precursor is disposed (e.g. coated) onto a set of reflective-layer-bearing microspheres and is then hardened to form a binder layer. As evident from FIG. 2, in the present approach, a binder layer 10 is “pre-made” before it is brought into contact with the transparent microspheres. By this is meant that prior to the binder material contacting the microspheres, the binder material has already spent at least some time in the form of a layer that is non-flowable and that, in particular, exhibits a definite, stable shape and form. Disposed on the front side of the pre-made binder layer 10 is a reflective sheet 30′, which is also pre-made (e.g., is pre-disposed on the front side of the binder layer). Pre-made binder layer 10, bearing reflective sheet 30′ thereupon, is brought into contact with a set of transparent microspheres 21 (e.g., the entities are laminated together with the use of appropriate heat and/or pressure). In some convenient embodiments, in order to perform such a lamination process the microspheres 21 can be provided on (e.g. partially, and detachably, embedded in) a carrier layer 110 as shown in FIG. 2; the microsphere portions 25 that protrude above the carrier layer will form the embedded portions of the microspheres when the carrier-borne microspheres and the binder layer are laminated together.

In such a lamination process, the non-uniform pressure resulting from the presence of the microspheres causes the reflective sheet 30′ to deform e.g. from its formerly planar shape of FIG. 2. That is, the reflective sheet 30′ is forced to “wrap” partially around the surfaces of the microspheres, which causes the reflective sheet 30′ to fracture e.g. to form gaps 34 as shown in exemplary, generic representation in FIG. 1. As will be appreciated from FIG. 1, the collection of thus-formed reflective layers 30 will exhibit a highly three-dimensional aspect, in contrast to e.g. an essentially planar state of the reflective sheet 30′ from which they were obtained.

In addition to causing reflective sheet 30′ to fracture and wrap at least partially around the embedded portions 25 of the microspheres, the lamination process will cause the binder layer 10 to deform so as to at least generally conform to the arcuate shape of the embedded portions 25 of the microspheres (and/or to the shape of any layer thereupon, e.g. an intervening layer 50 as discussed below). This will establish cavities 11 in binder layer 10 in which the embedded portions 25 of the microspheres reside. The binder layer 10 will at least bind to the microspheres (and /or any layer thereupon, e.g. an intervening layer 50) through the gaps 34 of the binder-borne reflective layer 30. This process also causes the binder, and the binder-borne reflective layer, to enter and to at least generally fill spaces that previously existed laterally between neighboring microspheres, as indicated in FIG. 1.

With use of the methods and compositions disclosed herein, the binder layer 10 and the set of microspheres 21 will remain well-bonded to each other (either directly, or e.g. via the use of an intervening, e.g. bonding, layer 50) upon ceasing the application of heat and/or pressure. A carrier 110 upon which the microspheres 21 were initially disposed may then be peeled off and removed, with the result that microspheres 21 remain securely in place on the front of binder layer 10 to provide retroreflective article 1.

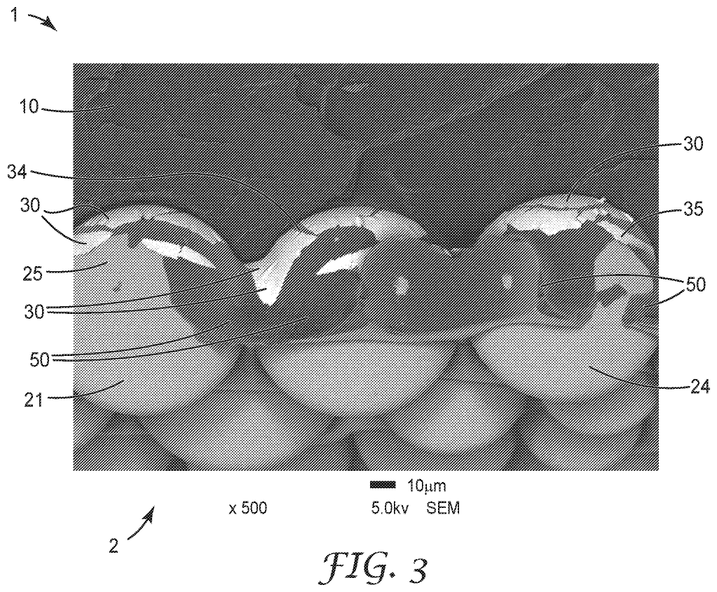

FIG. 1 is an exemplary representation provided to facilitate description and discussion of various features and characteristics of the herein-disclosed article. In actuality, transparent microspheres 21 may not be spaced exactly uniformly, an intervening layer 50 may exhibit varying thickness at different locations; and, of course, the fracturing of the reflective sheet 30′ may lead to considerable nonuniformity in the disposition and appearance of the resulting reflective layers 30. In order to illustrate features that may be expected, a back-scattering scanning electron microscope photograph of an exemplary Working Example retroreflective article is provided in FIG. 3. FIG. 3 was obtained by breaking a liquid-nitrogen-cooled retroreflective article and orienting the sample to obtain a cross-sectional view from roughly the same perspective as shown in FIG. 1. Visible in FIG. 3 are transparent microspheres 21, binder layer 10, discontinuous binder-borne reflective layers 30, and intervening layer 50. (It is possible that some portions of intervening layer 50 and reflective layers 30 were snapped off when the sample was broken; however, the portions that are visible are illustrative of the structure of this exemplary retroreflective article.)

FIG. 3 attests that the herein-disclosed process results in binder-borne reflective layers 30 that are discontinuous. That is, multiple gaps (one of which, randomly selected, is denotated by the reference number 34 in FIG. 3) are present at locations at which the original reflective sheet 30′ was fractured during the lamination process. FIG. 3 also reveals that reflective layers are often, e.g. consistently, present at locations laterally in between neighboring microspheres. Visual microscopy, although not illustrated in any Figure herein, further confirmed that reflective layers 30 were present (albeit in a discontinuous manner, with numerous gaps) throughout the length and breadth of the retroreflective article, including in locations laterally in between neighboring microspheres.

It has been found that a pre-made binder layer 10 with a pre-made reflective sheet 30′ disposed thereon can successfully be brought together (e.g. laminated) with a set of transparent microspheres in such manner that sufficient fracturing of the reflective sheet 30′ occurs to allow the formation of discontinuous reflective layers 30. It has further been found that the microspheres can remain bonded to the binder layer at the conclusion of this process. It has still further been found that a retroreflective article made in such a manner can exhibit excellent retroreflective performance. In particular, it has been found that such a retroreflective article can maintain this performance even after multiple washings (that is, the article can exhibit excellent wash durability), as evidenced by the Working Examples herein.

It is attested that these are surprising results. Specifically, the fact that a pre-made binder layer, bearing a pre-made reflective sheet on its front surface, can be conformed and bonded to a set of microspheres in such manner as to provide excellent, wash-durable retroreflective performance, is surprising. Such a lamination process requires the reflective sheet to fracture, shatter, fragment, and so on, to a sufficient amount to allow the binder layer to conform to the microspheres and fill the spaces laterally therebetween. It is postulated that such a process causes the reflective sheet to fracture to a degree sufficient to allow a significant portion of the bonding between the binder layer and the microspheres (or e.g. between the binder layer and intervening layers 50 provided on the microspheres) to occur by way of portions of the binder penetrating through gaps 34 (as shown in exemplary, generic representation in FIG. 1) that result from the fracturing of the reflective sheet 30′, so as to contact, and bond to, the microspheres and/or to an intervening layer thereon. The fact that a lamination process can cause the reflective sheet to fracture in such manner to allow sufficient bonding to achieve wash durability, while at the same time preserving the ability of the pieces of the fractured reflective sheet to provide excellent retroreflectivity, is unexpected.

The above discussions make it clear that by definition, a “binder-borne” reflective layer 30 will be positioned at least generally on the front side of the binder layer 10 (with the caveat that, as noted above, small portions of the binder may pass through gaps 34 that are formed in reflective layer 30 due to the fracturing process and thus may end up e.g. even with portions of reflective layer 30). In other words, in the arrangements disclosed herein the binder-borne reflective layers 30 will be on the same (front) side of the binder layer (and of the resulting retroreflective article) as the transparent microspheres. A rear surface 33 of a reflective layer 30 will thus be in contact with a front surface 12 of binder layer 10 (or with some layer, e.g. a tie-layer, that is provided atop binder layer 10). A front surface 32 of a reflective layer 30 may be in contact with a microsphere 21 and/or with an intervening layer 50 provided atop the microsphere.

A binder-borne reflective layer as disclosed herein is thus distinguished from a reflective “layer” that is achieved by the aggregate effect of reflective particles that are disposed within (e.g. admixed into) a binder material e.g. in the manner disclosed in U.S. Pat. Nos. 3,228,897, 4,763,985 and 9,671,533. And, at least by virtue of reflective layers 30 being located on the same side of binder layer 10 as the transparent microspheres 21, a binder-borne reflective layer is distinguished from a reflective layer that is disposed on an opposite side of a binder layer from transparent microspheres, e.g. in the manner disclosed in U.S. Pat. No. 4,226,658.

A binder-borne reflective layer 30 as disclosed herein is a discontinuous layer, meaning that it comprises at least some gaps 34 in which portions of a reflective sheet 30′ in FIG. 2 have completely separated from each other, as indicated in exemplary manner in FIG. 1 and as visible in FIG. 3. In some instances, gaps may be present in such magnitude and/or number that at least some “islands” (e.g. of a few tenths of microns, to microns in shortest dimension) 35 of reflective material may be present. However, this is not necessarily the case (and may depend on, for example, the brittleness of the reflective sheet 30′, the deformability of the binder layer (e.g. under heat and/or pressure), and/or particular manner in which the lamination process was formed, e.g. how much lamination pressure or how high a lamination temperature was used). Regardless of the particular extent of the fracturing in any given instance, it will be appreciated that the herein-disclosed reflective layers 30, at least by virtue of comprising gaps so as to be discontinuous, differ from the traditional vapor-coated reflective layers disclosed e.g. in U.S. Pat. Nos. 3,700,305 and 3,989,775, and the so-called layer-by-layer (LBL) coated reflective layers disclosed, e.g., in U.S. Pat. No. 10,054,724.

Although a binder-borne reflective layer 30 as disclosed herein may exhibit a superficial resemblance to the so-called “locally-laminated” reflective layers disclosed e.g. in International Patent Application Publication WO2019/084295, ordinary artisans will appreciate that such layers are quite different, and distinguishable, from each other. According to the WO '295 document a locally-laminated reflective layer is a local area of a pre-made reflective layer that is detached (broken away) from a surrounding area of the pre-made reflective layer, and is transferred to a transparent microsphere. The area of the reflective layer that formerly surrounded the local area is removed rather than remaining in the retroreflective article. Thus, a locally-laminated reflective layer will exhibit at least some edges that result from this local area being broken away from the surrounding areas of the original reflective sheet.

In contrast, for a binder-borne reflective layer 30 as disclosed herein, essentially the entirety of the pre-made reflective sheet 30′ remains in the retroreflective article. In other words, whenever a fracture occurs, the edges of the reflective layer on both sides of the fracture-formed gap will remain in the resulting retroreflective article. Therefore, binder-borne reflective layers 30 as disclosed herein will only have edges that result from a fracture/remain-in-place process rather than having a large number of edges that result from a fracture/removal process.

Such differences may be manifested, for example, in the fact that a locally-laminated reflective layer may often exhibit edges that are curled up away from the transparent microspheres (e.g. as evident in FIGS. 12A and 14A of the WO'295 document). In contrast, a binder-borne reflective layer 30 may exhibit relatively view few such curled-up edges, as is evident from FIG. 3 herein. While not wishing to be limited by theory or mechanism, it may be that the fact that the binder layer 10 remains constantly in place (thus pressing the reflective layers toward the microspheres) causes the edges of the binder-borne discontinuous reflective layers to remain held down rather than exhibiting a tendency to curl-up in the manner of locally-laminated reflective layers.

Another observable difference may be, for example, that a retroreflective article as disclosed herein will exhibit at least some reflective material (although such material may be e.g. fractured, deformed, and so on) in many or even all of the lateral areas between the microspheres, as noted above in the discussion of FIG. 3. In some embodiments, at least 50%, at least 60%, at least 70%, or at least 80% of the lateral areas between nearest-neighbor transparent microspheres will each have a discontinuous reflective layer 30 present therein. In contrast, for a locally-laminated retroreflective article the reflective material may often be largely limited to the embedded areas of the transparent microspheres. This is due to the fact that in local lamination the majority of the reflective material is often transferred to the “embedded” portions of the microspheres, with the remainder of the reflective material (in the areas laterally between the microspheres) typically being mostly removed as evident from FIG. 15 of the WO '295 document. (WO '295 does note that some so-called “bridging” reflective layers may occasionally be present in such locations; however, this appears to be readily distinguishable from the consistent existence of reflective material laterally between microspheres that is characteristic of binder-borne reflective layers.)

Thus in summary, from the disclosures herein, an ordinary artisan will be able to differentiate between binder-borne discontinuous reflective layers as disclosed herein and locally-laminated reflective layers as disclosed e.g. in the WO '295 document, by any number of readily identifiable features or characteristics.

Similar differentiation can also be found between the binder-borne discontinuous reflective layers and an embedded localized reflective layer as disclosed e.g. in International Patent Application Publication WO2019/084302. The embedded localized reflective layers such as those obtained by printing a reflective layer precursor (e.g. a silver ink) onto a microsphere or an intervening layer thereon have the reflective material largely limited to the embedded areas of the transparent microspheres. In contrast, the binder-borne discontinuous reflective layers have consistent existence of reflective material laterally between microspheres.

By definition, a binder-borne reflective layer as disclosed herein will be distinguished from any reflective layer that is disposed (whether by local-lamination, vapor-coating, printing, or any other method) on a transparent microsphere (or e.g. onto an intervening layer thereon) prior to an operation in which a binder layer (or binder layer precursor) is brought into contact with the microspheres. (Such reflective layers will be referred to herein as “transparent-microsphere-borne reflective layers, in further discussions herein.)

It will be clear from the above discussions that the claim feature of a discontinuous binder-borne reflective layer is not a purely product-by-process limitation, but rather can be identified, and distinguished from other reflective layers (e.g. aggregated reflective particles, vapor-coated or LBL coated reflective layers, locally-laminated reflective layers, or printed reflective layers), by any number of identifiable features, properties or characteristics that are a signature of an arrangement in which a pre-made binder-borne reflective sheet is fractured into discontinuous reflective layers as disclosed herein.

As noted above, in some embodiments a retroreflective element 20 may comprise at least one intervening layer 50 of organic polymeric material (e.g. transparent organic polymeric material) as shown in generic representation in FIG. 1 and as visible in FIG. 3. As indicated in FIG. 2, in some embodiments such an intervening layer may be disposed atop, and laterally in between, the protruding portions 25 of microspheres 21 as they reside atop a temporary carrier 110. For example, a precursor of such a layer may be coated or otherwise disposed atop the carrier and the microspheres present thereon and then transformed (e.g. by cooling, crosslinking, and so on) into the intervening layer. A forward surface 52 of layer 50 may thus be in contact with, and bonded to, transparent microspheres 21 or any layer present thereon. A rearward surface 53 may face outward so as to be contactable with the front side of a pre-made binder layer 10 bearing a reflective sheet 30′ in order to perform the herein-described lamination.

For clarity of description in some discussions herein, a portion of an intervening entity as present in any particular retroreflective element will be termed an intervening “layer”; an entire intervening entity, as present over the length and breadth of the carrier layer (and of the resulting retroreflective article) may sometimes be referred to as an intervening “stratum”. According to such terminology, any individual intervening layer will thus be a portion (rearward of a particular transparent microsphere) of a larger intervening stratum. Such an intervening stratum/layer of organic polymeric material may serve any desired function. In some embodiments it may serve as a physically-protective layer and/or a chemically-protective layer (e.g. that provides enhanced abrasion resistance, resistance to corrosion, etc.). In some embodiments such a layer may serve as a bonding layer (e.g. a tie layer or adhesion-promoting layer) that is capable of being bonded to by a binder layer. In some embodiments, such a layer may also be at least somewhat capable of being bonded to by a binder-borne reflective layer 30. In some embodiments an intervening layer may serve more than one purpose. In some embodiments, an intervening layer may be transparent (specifically, it may be at least essentially free of any colorant, pigment, dye, filler, or the like). Organic polymeric layers (e.g. protective layers) and potentially suitable compositions thereof are described in detail in U.S. Pat. No. 10,054,724, which is incorporated by reference in its entirety herein. In particular embodiments, such a layer may be comprised of a polyurethane material. Various polyurethane materials that may be suitable for such purposes are described e.g. in U.S. Pat. No. 10,545,268, which is incorporated by reference in its entirety herein.

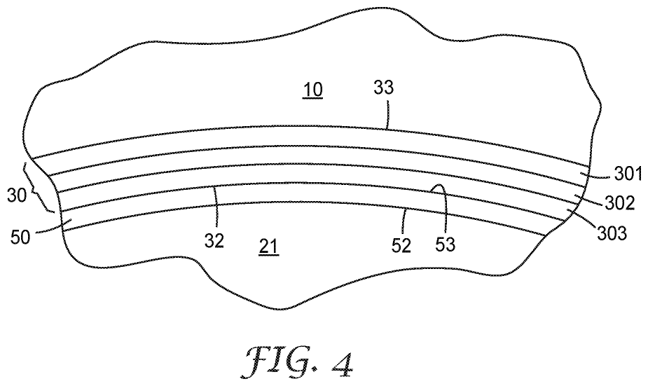

In some embodiments, a discontinuous binder-borne reflective layer 30 may take the form of a single layer of reflective material, e.g. a metal such as aluminum or silver. However, in some embodiments, a discontinuous binder-borne reflective layer 30 may be a multi-layer structure that comprises a reflecting layer 301 along with additional layers (e.g. transparent layers) such as e.g. an embrittlement layer 302 and/or a selective-bonding layer 303, as shown in exemplary embodiment in FIG. 4 and as discussed later herein. Thus according to the terminology used herein, the term “reflective layer” denotes an entity that includes at least a reflecting layer 301 and can also include other layers (e.g. an embrittlement layer 302 and/or a selective-bonding layer 303). The term “reflecting layer” denotes a specific layer 301 (e.g. a metal layer) of a reflective layer 30 that performs the actual reflecting of light (noting that in some embodiments a reflecting layer 301 itself may comprise sublayers, e.g. in the case that layer 301 is a dielectric stack as described below).

In some embodiments, a reflecting layer 301 of a discontinuous binder-borne reflective layer 30 may comprise a metal layer, e.g. a single layer, or multiple layers, of vapor-deposited metal (e.g. aluminum or silver), or of metal alloy.

In some embodiments, a reflecting layer may take the form of a dielectric reflecting layer, comprising an optical stack of pairs of high and low refractive index sublayers that are arranged in series along the optical path to provide reflective properties in combination. In some embodiments, a higher refractive index sublayer may be e.g. a niobium oxide layer (NbOₓ). In some embodiments, a lower refractive index sublayer may be e.g. an organic polymeric sublayer made of e.g. a (meth)acrylate material, or an inorganic sublayer such as a silicon oxide layer (SiOₓ) or a silicon aluminum oxide layer (SiAlOₓ). In various embodiments, one, two, three, or more pairs of high/low refractive index sublayers may be present. Dielectric reflecting layers are described in further detail in U.S. Pat. No. 10,545,268, which is incorporated by reference in its entirety herein for this purpose.

In particular embodiments, a dielectric reflecting layer may be a so-called layer-by-layer (LBL) structure in which each sublayer of the optical stack (i.e., each high-index sublayer and each low-index sublayer) is itself comprised of a substack of multiple bilayers. Each bilayer is in turn comprised of a first sub-layer (e.g. a positively charged sub-layer) and a second sub-layer (e.g. a negatively charged sub-layer). At least one sub-layer of the bilayers of the high-index substack will comprise ingredients that impart a high refractive index, while at least one sub-layer of the bilayers of the low-index substack will comprise ingredients that impart a low refractive index. LBL structures, methods of making such structures, and retroreflective articles comprising dielectric reflecting layers comprising such structures, are described in detail in U.S. Pat. No. 10,054,724, which is incorporated by reference in its entirety herein. In some embodiments a reflecting layer thus may comprise multiple sublayers. In some embodiments a hybrid configuration may be used in which metal reflecting layers and dielectric reflecting layers may both be present, e.g. as discussed in U.S. Pat. No. 10,197,714.

In some embodiments a discontinuous binder-borne reflective layer 30 may consist essentially of a reflecting layer (e.g. a metal layer or a dielectric stack). In other embodiments, reflective layer 30 may be a multilayer structure comprising other layers in addition to a reflecting layer 301, as noted above. In some embodiments, a discontinuous binder-borne reflective layer 30 may comprise at least one embrittlement layer 302 and/or at least one selective-bonding layer 303. Typically, any such additional layer will be present in the original reflective sheet 30′ and will be fractured along with the other layers (e.g. a reflecting layer 301) during the lamination process to form individual reflective layers 30.

In embodiments of the type shown in FIG. 4, a reflective layer 30 may comprise an embrittlement layer 302 that is positioned forward of reflecting layer 301 and a selective-bonding layer 303 that is forward of embrittlement layer 302. In such an arrangement, a rearward surface of reflecting layer 301 may provide a rearward surface 33 of reflective layer 30 (that is e.g. in contact with a forward surface 12 of binder 10). A forward surface of selective-bonding layer 303 may provide a forward surface 32 of reflective layer 30. However, any suitable order of reflecting layer(s) 301, embrittlement layer(s) 302, and/or selective-bonding layer(s) 303 is allowable. Any such layer (or layers) present in the retroreflective light pathway (e.g. both layer embrittlement layer 302 and selective-bonding layer 303 in FIG. 4) will be configured so as to not unduly interfere with the passage of light therethrough. For example, all such layers may be transparent. In some embodiments a selective-bonding layer 303 and/or an embrittlement layer 302 may serve as a sublayer of a dielectric stack and may thus contribute to the reflection that is achieved in addition to its other function. For example, in some embodiments an oxide layer may provide embrittlement and may also serve as a low-refractive-index sublayer of a dielectric stack. In some embodiments (e.g. in which a dielectric stack includes multiple sets of high-low refractive index sublayers), multiple embrittlement layers may be present which operate in combination to provide the desired embrittlement.

An embrittlement layer 302 may be any layer that exhibits suitably brittle properties that can enhance the ability of a pre-made reflective sheet to fracture in the manner disclosed herein. Many silicon oxides (e.g. silicon aluminum oxide (SiAlOₓ), as achieved e.g. by sputter-coating from a target comprising silicon and aluminum (SiAl), in an oxygen-containing atmosphere) may be well-suited for such applications (noting that the embrittlement layer is optional and may be included or omitted in various circumstances). It has been found that in at least some circumstances, the presence of an embrittlement layer can enhance the ability of a binder-borne reflective sheet 30′ to be fractured so as to achieve the effects disclosed herein.

A selective-bonding layer 303 may comprise any material that exhibits a desired combination of releasability at one major surface and bonding at the other, opposing major surface. In many embodiments such a material may be chosen from various (meth)acrylate and/or (meth)acrylamide materials as discussed in U.S. Provisional Patent Application 62/478,992 and the resulting International Patent Application Publication WO2018/178802, both of which are incorporated in their entirety herein. If the selective-bonding layer is to be formed by flash evaporation of the monomer, vapor deposition, followed by crosslinking, volatilizable (meth)acrylate and/or (meth)acrylamide monomers or oligomers may be used. Suitable materials will exhibit sufficient vapor pressure to be evaporated in an evaporator and condensed into a liquid or solid coating in a vapor coater. Examples of potentially suitable materials and methods of processing are listed in the '992 provisional application. Tricyclodecane dimethanol diacrylate is a particular example of a suitable material, and may be conveniently applied by, e.g., condensed organic coating followed by UV, electron beam, or plasma initiated free radical polymerization.

The presence of a selective-bonding layer 303 is optional. In many instances, a selective-bonding layer may be present primarily because of the usefulness of such a layer in allowing a pre-made reflective layer to be disposed on a pre-made binder layer by certain lamination techniques as discussed later herein. Such a layer is allowed to remain in the final retroreflective article as long as the layer does not unacceptably affect the properties of the article. If a reflective sheet (and the resulting reflective layers) does include a selective-bonding layer, a selective-release surface of the selective-bonding layer may, in some circumstances, provide a weakly-bonded interface to some other layer of the reflective layer or of the article. In such cases, the arrangements disclosed herein, in which the reflective sheet is fractured so that bonding of a binder layer to e.g. an intervening layer can occur through the gaps caused by the fracturing, are advantageous in allowing sufficient bonding to be achieved even in the presence of a selective-bonding layer.

In some embodiments a binder-borne reflective layer may comprise an optical retarder that is positioned e.g. forward of the reflective layer 30. Such an optical retarder is a layer (or sublayer) that selectively slows one of the orthogonal components of light to change its polarization. In some embodiments, such an optical retarder may be configured as a quarter-wave retarder that, for a certain wavelength of interest λ, has a retardance of λ/4. A quarter-wave retarder for a given wavelength of light will change the light of that wavelength from circularly polarized light to linear polarized light or vice versa. Optical retarders are described and discussed in detail in U.S. Provisional Patent Application 62/610,180 and in PCT International Patent Application No. WO2019/082162, both of which are incorporated by reference in their entirety herein.

A discontinuous, binder-borne reflective layer 30 may exhibit any suitable thickness. If reflective layer 30 includes multiple layers, the thickness of any such layer can be chosen as desired. In various embodiments, a reflective layer 30 may exhibit a total thickness of from at least 0.01, 0.05, 0.1, 0.2, 0.5, 1, 2, 4, or 8 microns, to at most 40, 20, 10, 7, 5, 4, 3, 2 or 1 microns. In various embodiments, a reflecting layer 301 of a reflective layer 30 may vary from e.g. 10, 20, 40 or 80 nm to 40, 20, 10, 7, 5, 4, 3, 2 or 1 microns. In various embodiments, an embrittlement layer 302, if present, may vary in thickness from e.g. 1, 2, 4 or 6 nm to 100, 80, 60, 40, 30 or 20 nm. In various embodiments, a selective-bonding layer 303, if present, may vary from e.g. 20, 40 or 60 nm to 500, 400, 300, 200 or 100 nm.

In many embodiments, a characteristic of discontinuous binder-borne reflective layers 30 as disclosed herein will be the extreme uniformity and consistency of the thickness of the layers. This is because all of the reflective layers 30 will have been obtained from the same reflective sheet 30′. And, since such a reflective sheet is premade, in a planar format, it is possible for reflective sheet 30′ to exhibit extremely uniform thickness over its length and breadth. Thus, in many cases the uniformity and consistency of the thickness of the various reflective layers 30 will be another signature of discontinuous binder-borne reflective layers and can allow such reflective layers to be distinguished from various other types of reflective layers.

In some embodiments (e.g. when no intervening layer 50 is present), at least some portions of some reflective layers 30 (e.g. in areas that are laterally in between microspheres) may be exposed at the forward surface 14 of retroreflective article 1. In other embodiments (e.g. in which an intervening layer 50 is present, as in FIG. 1), generally, substantially, or essentially all reflective layers may be embedded reflective layers. By an embedded reflective layer is meant a reflective layer that is completely surrounded (e.g. sandwiched) by the combination of at least binder layer 10, intervening layer 50, and transparent microsphere 21 (noting that in some embodiments some other layer or layers, e.g. a color layer, may also be present and may contribute to the surrounding of the reflective layer). In other words, all portions of an embedded reflective layer will be “buried” (as depicted in exemplary embodiment in FIG. 1) between the transparent microsphere 21, the binder layer 10, and one or more additional layers, rather than being exposed at the front surface 14 of the retroreflective article.

As noted earlier herein, binder layer 10 is configured to support and retain transparent microspheres 21 and to provide retroreflective article 1 with mechanical integrity (so that article 1 can be, for example, attached to a substrate, sewn to an article of clothing, etc.). In various embodiments, binder layer 10 may exhibit an average thickness of from 1 to 2000 micrometers. In further embodiments, binder layer 10 may exhibit an average thickness of from 30 to 250 micrometers. In some embodiments binder layer 10 may be at least generally visibly transmissive (e.g. transparent). In many convenient embodiments binder layer 10 may comprise one or more colorants. In particular embodiments a binder may comprise one or more fluorescent pigments. Suitable colorants (e.g. pigments) may be chosen e.g. from those listed in the '444 and '844 U.S. Provisional Applications that were referred to earlier herein.

In some embodiments a binder layer as originally made (e.g. as depicted in FIG. 2, before being laminated with a set of transparent microspheres) may comprise front and rear major surfaces 12 and 13 that are co-planar However, after the herein-disclosed lamination process, the front major surface 12 will have deformed substantially to allow the penetration of portions 25 of microspheres 21 into binder layer 10 so that portions 25 reside in cavities 11 of binder layer 10, as shown in FIG. 1.

Binder layer 10 may be of any suitable composition that allows binder layer 10 to be premade, that allows a reflective sheet 30′ to be disposed thereon (or vice versa), and that is sufficiently deformable e.g. in a lamination process to allow the reflective-sheet-bearing binder layer to be laminated together with a set of transparent microspheres so as to achieve the structures and arrangements disclosed herein.

In some embodiments, binder layer 10 may be a composition of the general type disclosed in U.S. Provisional Patent Application No. 62/785,326, which is incorporated by reference in its entirety herein. Such compositions may comprise e.g. styrenic block copolymers in combination with one or more suitable tackifiers, e.g. tackifiers comprising non-carbon hetero-atom functionality. In some embodiments, binder layer 10 may be a composition of the general type disclosed in U.S. Provisional Patent Application No. 62/785,344, which is incorporated by reference in its entirety herein. Such compositions may comprise e.g. at least one tackifier and at least one elastomer selected from at least one of natural rubbers and synthetic rubbers (e.g. an elastomeric styrenic block copolymer).

To form a binder layer, such a composition may, for example, be disposed onto a pre-made reflective sheet 30′ e.g. by hot melt coating (that is, it may be coated onto sheet 30′ while at a sufficiently high temperature to be in a flowable state). The coated composition may then be cooled e.g. to room temperature, under which condition it may be relatively solid (i.e., non-flowable) and of stable form and able to be handled by conventional film-handling processes. The resulting reflective-sheet-bearing binder layer may then be laminated together with a set of transparent microspheres, e.g. at an appropriately elevated temperature and with appropriate lamination pressure, to form a retroreflective article. Such a lamination temperature will typically be lower than the temperature that was used to render the composition flowable for the initial hot melt coating process. That is, even if the composition may be flowable e.g. at a high temperature initially used for hot melt coating, it typically will not be flowable/coatable at the temperature (and pressure) used for lamination. (However, it will be sufficiently deformable under those conditions to allow the results described herein to be achieved.)

In some embodiments, binder layer 10 may be of a composition of the general type disclosed in U.S. Provisional Patent Application No. 62/522,279 and resulting International Patent Application Publication WO2018/236783, and in U.S. Provisional Patent Application No. 62/527,090 and resulting International Patent Application Publication WO2019/003158, all of which are incorporated by reference in their entirety herein. These documents describe various curable (meth)acrylate formulations that may be useful for forming a “bead bond layer” (e.g. i.e. a binder layer). For example, the US'090 document describes compositions that may comprise polymerized units of one or more (meth)acrylate ester monomers derived from an alcohol containing 1 to 14 carbon atoms, and at least one of urethane acrylate polymer or acrylic copolymer. The US'279 document describes compositions that may comprise polymerized units of one or more (meth)acrylate ester monomers derived from an alcohol containing 1 to 14 carbon atoms, and polyvinyl acetal resin.

These documents primarily describe formulations that are handled by being disposed onto carrier-borne transparent microspheres and cured. In the present arrangements, while similar formulations may be used, they are handled quite differently. For example, such a formulation, while in a flowable state, may be disposed (e.g. by coating) onto a pre-made reflective sheet 30′. While in this form, the formulation may then be cured to an appropriate degree (which may be controlled e.g. by the amount of trifunctional crosslinker in the composition, as will be readily understood) to provide a binder layer with appropriate physical properties that allow the reflective-sheet-bearing binder layer to be laminated together with a set of transparent microspheres. In some embodiments, the binder layer may be post-cured after the lamination process if desired in order to attain the final, desired properties.

A binder layer as present in the form of a reflective-sheet-bearing binder layer, and particularly in the finished retroreflective article, will not be a flowable material at room temperature. By this is meant that the binder layer will exhibit a viscosity that is greater than 10⁸ cps. (In many instances, the viscosity will be so high as to not be measurable with any practical method). Such a binder layer may be e.g. heated to conditions (e.g. 90 degrees C.) that, together with an appropriate lamination pressure, cause the binder layer to soften and become deformable to an extent to allow the herein-described lamination to be performed. However, in many embodiments, even at such high temperatures the binder layer may still exhibit such a high viscosity that it cannot be considered to be a flowable material under the conditions used for lamination (Thus, the term “deformable” is typically used herein, in order to designate a layer that can be conformed to the shape of transparent microspheres in a lamination process, but that cannot be coated in a conventional sense under the lamination conditions used.)

Any such binder layer, regardless of the particular composition and/or manner in which it was formed, will retain the transparent microspheres and will provide the retroreflective article with necessary integrity for its normal usage. In particular, the binder layer can enable the retroreflective article to exhibit excellent wash durability as discussed elsewhere herein.

In some particular embodiments, binder layer 10 may contain reflective particles, e.g. flakes, of reflective material (e.g. nacreous or pearlescent material). Such reflective particles may be e.g. dispersed within (admixed into) the material of binder layer 10 so that at least a portion of binder layer 10 that is adjacent to a transparent microsphere 21 can function as an auxiliary reflective layer. By an “auxiliary” reflective layer is meant a set of reflective particles dispersed within a binder layer 10 that collectively serve to enhance the performance of a retroreflective element above the performance provided by a discontinuous binder-borne reflective layer 30. That is, such an auxiliary reflective layer (which may not necessarily have a well-defined rearward boundary) may provide at least some additional retroreflection due to the aggregate effects of the reflective particles that are present in the layer. Details of binder layers comprising reflective particles dispersed therein are found e.g. in U.S. Provisional Patent Application No. 62/739,529 and in resulting International Patent Application Publication WO2019/084299, both of which are incorporated by reference in their entirety herein. In other embodiments, no such reflective particles that contribute any meaningful amount of retroreflection will be present in binder 10.

In some embodiments at least some of the retroreflective elements 20 of a herein-disclosed retroreflective article 1 may comprise at least one color layer. The term “color layer” is used to signify a layer that preferentially allows passage of electromagnetic radiation in at least one wavelength range while preferentially minimizing passage of electromagnetic radiation in at least one other wavelength range by absorbing at least some of the radiation of that wavelength range. In some embodiments a color layer will selectively allow passage of visible light of one wavelength range while reducing or minimizing passage of visible light of another wavelength range. In some embodiments a color layer will selectively allow passage of visible light of at least one wavelength range while reducing or minimizing passage of light of near-infrared (700-1400 nm) wavelength range. In some embodiments a color layer will selectively allow passage of near-infrared radiation while reducing or minimizing passage of visible light of at least one wavelength range. A color layer as defined herein performs wavelength-selective absorption of electromagnetic radiation by the use of a colorant (e.g. a dye or pigment) that is disposed in the color layer. A color layer is thus distinguished from a reflective layer (and from a transparent layer), as will be well understood by ordinary artisans based on the discussions herein.

Any such color layer can be arranged so that light that is retroreflected by a retroreflective element 20 passes through the color layer so that the retroreflected light exhibits a color imparted by the color layer. A color layer can be disposed, for example, so that at least a portion of the color layer is located between a rearward surface of embedded area 25 of transparent microsphere 21 and a forward surface 32 of reflective layer 30 so that at least this portion of the color layer is in the retroreflective light path. In some embodiments an above-mentioned intervening layer (e.g. a transparent layer) 50 may be present in addition to a color layer; such layers may be provided in any order (e.g. with the color layer forward of, or rearward of, the intervening layer) as desired. In some embodiments, a color layer may serve some other function (e.g. as a bonding layer, an adhesion-promoting layer, or a tie layer) in addition to imparting color to the retroreflected light.

The presence of color layers (e.g. localized, embedded color layers) in at least some of the retroreflective light paths of a retroreflective article can allow article 1 to comprise at least some areas that exhibit colored retroreflected light, irrespective of the color(s) that these areas (or any other areas of the article) exhibit in ambient (non-retroreflected) light. Some such arrangements may enable the color layer to mask the reflective layer for advantageously enhanced color appearance in ambient (non-retroreflective) light. Some such arrangements can provide that retroreflected light can exhibit different colors depending on the entrance/exit angle of the light. Color layers are described in further detail e.g. in U.S. Provisional Patent Application No. 62/675,020 and the resulting International Patent Application Publication WO2019/084297, both of which are incorporated by reference in their entirety herein.

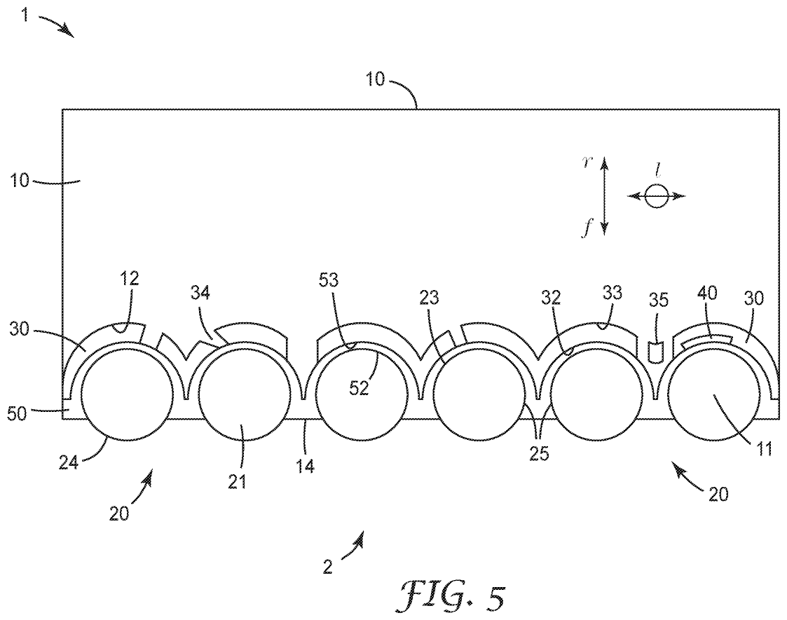

In some embodiments, a retroreflective element 20 may be configured so that a herein-disclosed discontinuous binder-borne reflective layer 30 is the only reflective layer that is present in the retroreflective element (as in the exemplary design of FIG. 1). However, in other embodiments, at least one additional reflective layer may be present that is a transparent-microsphere-borne reflective layer. By this terminology is meant a reflective layer that is disposed on a portion of a transparent microsphere before the transparent microsphere is brought together with a binder-borne reflective layer to form a retroreflective article. A retroreflective element that includes a transparent-microsphere-borne reflective layer 40 is shown in exemplary embodiment in FIG. 5. Such a retroreflective element will thus comprise (at least) two reflective layers, a transparent-microsphere-borne layer 40 and a binder-borne layer 30.

A microsphere-borne reflective layer 40 may be arranged in any desired geometric configuration, as described in detail in U.S. Provisional Patent Application No. 62/739,489 and in resulting International Patent Application Publication No. WO2019/084302, both of which are incorporated by reference in their entirety herein. In particular embodiments, a microsphere-borne reflective layer 40 may be a locally-laminated reflective layer, as described in detail in U.S. Provisional Patent Application No. 62/739,506 and in resulting International Patent Application Publication No. WO2019/084295, both of which are also incorporated by reference in their entirety herein. These documents also discuss various methods by which reflective layers may be disposed onto transparent microspheres to provide microsphere-borne reflective layers.

It will be appreciated that arrangements involving both microsphere-borne reflective layers and binder-borne reflective layers may be able to achieve unique combinations of, for example, retroreflective performance and appearance in ambient (non-retroreflective) light. By way of one particular example, a microsphere-borne reflective layer 40 (e.g. a silver or aluminum layer) may be provided in a “polar-cap” configuration as described in the above-cited US '506 document, and may provide excellent retroreflectivity to “head-on” light. A binder-borne reflective layer 30 may be present e.g. in the form of a dielectric stack that exhibits excellent retroreflectivity at certain wavelengths and that passes light at other wavelengths. This binder-borne reflective layer, if it occupies a greater arc of the microsphere than that occupied by the “polar-cap” reflective layer, may provide at least some additional retroreflection at “off-angles” (angles far from head-on) at which light is not retroreflected by the “polar-cap” reflective layer. At the same time, the binder-borne reflective layer may be sufficiently transparent at some wavelengths to allow the color of a binder layer of the retroreflective article to be visible in ambient light. Such arrangements may thus allow the production of a retroreflective article that can pass any of various retroreflectivity performance tests while still allowing the native color of the article (e.g., fluorescent yellow, as imparted by a colorant in the binder layer) to be visible in ambient light.

It will be appreciated that this is only one example of numerous possible arrangements of microsphere-borne reflective layers and binder-borne reflective layers. The disclosures of the above-noted US'506 and US'489 documents will provide ordinary artisans with numerous additional possible configurations and arrangements, for various effects.

Still further, in some embodiments, multiple (e.g. two or more) microsphere-borne reflective layers (e.g., locally-laminated layers), may be present, as described in detail in U.S. Provisional Patent Application Nos. 62/838,569 and 62/838,580, both of which are incorporated by reference in their entirety herein. Still further effects and combinations may be achieved when multiple microsphere-borne reflective layers are used in combination with binder-borne reflective layers. In embodiments in which one or more microsphere-borne reflective layers are present, an intervening layer may have been provided on the microspheres before any microsphere-borne reflective layer(s) is disposed thereon. Or, an intervening layer may be disposed rearwards of a microsphere-borne reflective layer e.g. in order to enhance the adhesion of a binder layer subsequently applied thereto.

From the above discussions it will be appreciated that a binder-borne reflective layer can be used in any of numerous arrangements and combinations. For example, in some instances a binder-borne reflective layer may be the only reflective layer of a retroreflective element. In some embodiments a binder-borne reflective layer may used in combination with a single microsphere-born reflective layer, of any of a number of possible constructions, geometric properties and so on. In some embodiments a binder-borne reflective layer may be used in combination with a multiple in-series microsphere-born reflective layers, each being chosen from any of a number of possible constructions, geometric properties and so on. In some embodiments a binder-borne reflective layer may be used in combination with an auxiliary reflective layer provided by reflective particles that are dispersed in the binder layer. And, in some embodiments a binder-borne reflective layer may be used in combination with e.g. a color layer, an optical retarder layer, and so on. Various combinations of any of the above arrangements may be envisioned.

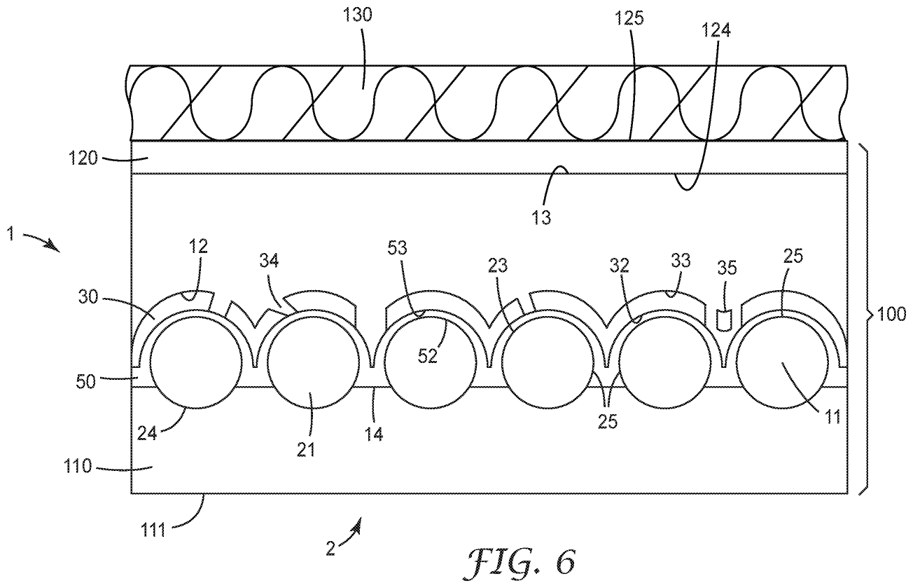

In some embodiments of the general type shown in FIG. 6, a retroreflective article 1 as disclosed herein may be provided as part of a transfer article 100 that comprises retroreflective article 1 along with a removable (disposable) carrier layer 110 that comprises front and rear major surfaces 111 and 112. In some convenient embodiments, retroreflective article 1 may be built on such a carrier layer 110, which may be removed for eventual use of article 1 as described later herein. For example, a front side 2 of article 1 may be in releasable contact with a rear surface 112 of a carrier layer 110, as shown in exemplary embodiment in FIG. 6.

Retroreflective article 1 (e.g. while still a part of a transfer article 100) may be coupled to any desired substrate 130, as shown in FIG. 6. This may be done in any suitable manner. In some embodiments this may be done by the use of a bonding layer 120 that couples article 1 to substrate 130 with the rear side 3 of article 1 facing substrate 130. Such a bonding layer 120 can bond binder layer 10 (or any layer rearwardly disposed thereon) of article 1 to substrate 130, e.g. with one major surface 124 of bonding layer 120 being bonded to rear surface 13 of binder layer 10, and with the other, opposing major surface 125 of bonding layer 120 bonded to substrate 130. Such a bonding layer 120 may be e.g. a pressure-sensitive adhesive (of any suitable type and composition) or a heat-activated adhesive (e.g. an “iron-on” bonding layer). Various pressure-sensitive adhesives are described in detail in U.S. Pat. No. 10,054,724, which is incorporated by reference in its entirety herein.

The term “substrate” is used broadly and encompasses any item, portion of an item, or collection of items, to which it is desired to e.g. couple or mount a retroreflective article 1. Furthermore, the concept of a retroreflective article that is coupled to or mounted on a substrate is not limited to a configuration in which the retroreflective article is e.g. attached to a major surface of the substrate. Rather, in some embodiments a retroreflective article may be e.g. a strip, filament, or any suitable high-aspect ratio article that is e.g. threaded, woven, sewn or otherwise inserted into and/or through a substrate so that at least some portions of the retroreflective article are visible. In fact, such a retroreflective article (e.g. in the form of a yarn) may be assembled (e.g. woven) with other, e.g. non-retroreflective articles (e.g. non-retroreflective yarns) to form a substrate in which at least some portions of the retroreflective article are visible. The concept of a retroreflective article that is coupled to a substrate thus encompasses cases in which the article effectively becomes a part of the substrate.

In some embodiments, substrate 130 may be a portion of a garment. The term “garment” is used broadly, and generally encompasses any item or portion thereof that is intended to be worn, carried, or otherwise present on or near the body of a user. In such embodiments article 1 may be coupled directly to a garment e.g. by a bonding layer 120 (or by sewing, or any other suitable method). In other embodiments substrate 130 may itself be a support layer to which article 1 is coupled e.g. by bonding or sewing and that adds mechanical integrity and stability to the article. The entire assembly, including the support layer, can then be coupled to any suitable item (e.g. a garment) as desired. Often, it may be convenient for carrier 110 to remain in place during the coupling of article 1 to a desired entity and to then be removed after the coupling is complete. Strictly speaking, while carrier 110 remains in place on the front side of article 1, the areas 24 of transparent microspheres 21 will not yet be air-exposed and thus the retroreflective elements 20 may not yet exhibit the desired level of retroreflectivity. However, an article 1 that is detachably disposed on a carrier 110 that is to be removed for actual use of article 1 as a retroreflector, will still be considered to be a retroreflective article as characterized herein.

Methods of Making

As noted earlier herein, in the present approach, a pre-made binder layer 10 bearing a pre-made, reflective sheet 30′ on a front side thereof is brought into contact with a set of transparent microspheres, e.g. by a lamination process, to form a retroreflective article comprising discontinuous, binder-borne reflective layers 30. In this process, the binder layer 10 is heavily deformed, and reflective sheet 30′ is heavily fractured, to form the structures and arrangements described in detail earlier herein.

A reflective sheet 30′ as input to a lamination process can have any suitable form. In some embodiments a pre-made reflective sheet 30′ may be a continuous reflective sheet. The term “continuous” as used to describe reflective sheet 30′, is synonymous with “substantially unfractured”. Thus in some embodiments a reflective sheet 30′, as initially made, may be a continuous reflective sheet. If such a reflective sheet is preserved in this condition, it may be a continuous reflective sheet up to the time at which it is input into the lamination process. It is noted that even a continuous reflective sheet may, in some embodiments, be patterned so as to have areas purposefully lacking in reflectivity.

It has been found that in many instances (particularly when a pre-made reflective sheet has been transferred to a pre-made binder layer by a preliminary lamination process in the general manner disclosed later herein) the reflective sheet 30′ may exhibit at least some fractures/cracks that apparently arise due to the stresses of handling the reflective sheet. In some instances, there may be numerous such cracks. It has been found, however, that such handling typically results in cracks in which the opposing edges of the crack do not separate from each other to a significant extent. Rather, the edges remain in close proximity to each other (such fractures may thus be referred to as “greenstick” fractures or “hairline” fractures). A reflective sheet that exhibits fractures, which may be quite numerous, but in which the vast majority of the fractures are greenstick fractures, will be referred to as a “contiguous” reflective sheet.

Thus in some embodiments a reflective sheet 30′ as present on a pre-made binder layer and as input into a lamination process, may be a contiguous reflective sheet rather than e.g. a continuous reflective sheet. However, it has still further been discovered that in some instances it may be advantageous to “pre-emboss” a reflective sheet 30′ (as present on a pre-made binder). By pre-embossing is meant any process that imparts significant pressure, shear, or the like, to reflective sheet 30′ so that sheet 30′ exhibits a significant number of fractures in which the edges of the thus-formed cracks have significantly separated from each other. It has been found that performing such a pre-embossing process can, in some instances, enhance the ability of reflective sheet 30′ to further fracture in a subsequent lamination process so that the resulting reflective layers more fully conform to the shape of the transparent microspheres.

Thus in some embodiments a reflective sheet 30′ as present on a pre-made binder layer and as input into a lamination process, may be a pre-embossed reflective sheet. (A pre-embossing process thus may be considered to be a preliminary step in the herein-disclosed lamination process.) A pre-embossing process can take any suitable form. For example, a reflective-sheet-bearing binder layer may be fed through a set of patterned nip rolls that impart significant local shear. Or, a pre-embossing process might simply involve passing a reflective-sheet-bearing binder layer around a roll of sufficiently small radius. Any such process may achieve the desired effect. It is emphasized that even if a reflective sheet 30′ as input to a lamination process has been pre-embossed, the process of laminating the sheet (and binder layer) to a set of transparent microspheres will often result in a large amount of additional fracturing, both in terms of the number of fractures and the separation between the fractured edges.

In some convenient embodiments, in order to perform a lamination process the microspheres 21 can be provided on (e.g. partially embedded in) a carrier layer 110 as shown in FIG. 2; the microsphere portions 25 that protrude above the carrier layer will form the embedded portions of the microspheres when the carrier-borne microspheres and the binder layer are laminated together.

Thus as disclosed herein a reflective-layer-bearing binder layer 10 and a set of microspheres 21 (e.g. borne on a carrier layer 110) can be laminated together with the use of appropriate heat and/or pressure as achieved e.g. by a pair of lamination tools. In some embodiments this may be done with both of these entities in a planar configuration, e.g. by placing the entities into a platen press and pressing them together, e.g. while maintaining one or both of them at a temperature suitable to allow binder layer 10 to be sufficiently deformable. However, in some convenient embodiments the lamination may be performed by feeding the entities through a nip roll. Thus, in some such processes one or both of these entities may temporarily be in a slightly arcuate configuration during a portion of the lamination process. (It will thus be appreciated that FIG. 2 is a generic, idealized representation of lamination that does not attempt to show any particular curvature that is temporarily established during lamination.)

Such a nip roll may, for example, comprise first and second laminations tools in the form of a first backing roll that supports the binder layer and a second backing roll that supports the carrier layer, with a suitable gap established at the point of closest approach of the surfaces of the first and second backing rolls. The surfaces of each backing roll may be chosen with any suitable hardness; for example, the surface may be steel or other metal, or may be e.g. equipped with a coating or sleeve of e.g. silicone rubber or the like, of any suitable thickness and durometer. In some embodiments the surfaces of one or both lamination tools (e.g. backing rolls) may be smooth, e.g. so that the lamination is performed uniformly over the length and breadth of the binder layer and the thus-produced retroreflective article. In other embodiments, one or both tools may be patterned (e.g. with a set of plateaus interrupted by recessed areas) so that the herein-described conforming of the binder layer to the transparent microspheres only occurs in certain areas.

The force with which the lamination tools (e.g. backing rolls) are pressed together may be chosen as desired. One or both tools may be temperature-controlled e.g. by the use of a heat-transfer fluid that is heated or cooled by some external source and circulates through the interior of the backing roll. In some embodiments, one or both of the binder layer and the carrier layer can be heated by some means other than a backing roll (whether in addition to, or instead of, the use of a heated backing roll). For example, in some embodiments a binder layer may be pre-heated e.g. by use of an infrared lamp, prior to the binder layer entering the nip.

In various embodiments a lamination process as disclosed herein may be carried out using lamination tools that are heated to at least 40, 50, 60, 70, 80 or 90 degrees C. In further embodiments, such a lamination process may use lamination tools that are heated to no higher than 180, 160, 140, 120, 100, or 80 degree C. In various embodiments a lamination process as disclosed herein may be carried out with backing rolls pressed together to provide a nip pressure of at least 20, 50, 100, 200, or 400 pounds per linear inch. In further embodiments such a lamination process may be carried out with backing rolls pressed together to provide a nip pressure of at most 1500, 1000, 700, 500, 300, 250, or 150 pounds per linear inch. In some embodiments a lamination process as disclosed herein may be carried out with a set of platen tools pressed together to provide a pressure of at least 20, 30, 40, or 60 pounds per square inch.

As noted above, in some convenient embodiments, a set of transparent microspheres may be disposed on a carrier layer 110 in order to perform the above-described lamination In such an instance, transparent microspheres 21 can be partially (and detachably) embedded into a carrier layer 110 to form a substantially mono-layer of microspheres. For such purposes, in some embodiments carrier layer 110 may comprise e.g. a heat-softenable polymeric material that can be heated and the microspheres deposited thereonto in such manner that they partially embed therein. The carrier layer can then be cooled so as to releasably retain the microspheres in that condition for further processing. The composition of at least the surface of the carrier into which the microspheres are embedded, can be chosen to ensure that the microspheres are able to detach from the carrier when the carrier is peeled away from the retroreflective article after the above-described lamination is complete.

Typically, the microspheres as deposited are at least slightly laterally spaced apart from each other although occasional microspheres may be in lateral contact with each other. The pattern (that is, the packing density or proportional area coverage) of microspheres as deposited on the carrier will dictate their pattern in the final article. In various embodiments, the microspheres may be present on the final article at a packing density of at least 30, 40, 50, 60 or 70 percent (whether over the entire article, or in microsphere-containing macroscopic areas of the article). In further embodiments, the microspheres may exhibit a packing density of at most 80, 75, 65, 55 or 45 percent (noting that the theoretical maximum packing density of monodisperse spheres on a plane is in the range of approximately 90 percent). In some embodiments the microspheres may be provided in a predetermined pattern, e.g. by using the methods described in U.S. Patent Application Publication 2017/0293056, which is incorporated by reference herein in its entirety.

In various embodiments the microspheres 21 may be partially embedded in carrier 110 e.g. to about 20 to 50 percent of the microspheres' diameter. The areas 25 of microspheres 21 that are not embedded in the carrier protrude outward from the carrier so that they can penetrate into binder layer 10 (and cause binder-borne reflective sheet 30′ to fracture) during the lamination process. These areas 25 (which will form the embedded areas 25 of the microspheres in the final article) will be referred to herein as protruding areas of the microspheres during the time that the microspheres are disposed on the carrier layer in the absence of a binder layer. In customary manufacturing processes, there may be some variation in how deeply the different microspheres are embedded into carrier 110, which may e.g. affect the degree to which an area of binder-borne reflective sheet 30′ that contacts any particular microsphere becomes fractured in the lamination process.

Further details of suitable carrier layers, methods of temporarily embedding transparent microspheres in carrier layers, and methods of using such layers to produce retroreflective articles, are disclosed in U.S. Pat. No. 10,054,724.

In some embodiments, after microspheres 21 are partially embedded in carrier 110, an intervening layer 50 can be disposed atop protruding areas of the microspheres. Typically, such an intervening layer will also be disposed on areas of surface 112 of carrier 110 that are laterally in between the microspheres, as shown in FIG. 2. Such an intervening layer 50 may serve multiple purposes. First, it may be chosen so that it bonds well to the transparent microspheres 21 (or to a layer thereon). Second, it may be chosen so that binder layer 10 can bond well to it. (Thus, in some instances a binder layer may bond more aggressively to an intervening layer 50 than it would to a microsphere, thus enhancing the mechanical integrity of the finished retroreflective article.) In some instances, an intervening layer may be chosen so that it exhibits at least some ability to bond to a binder-borne reflective layer, e.g. so that a microsphere need not be held in place purely by way of bonding between the binder layer and an intervening layer, through gaps in the reflective layer.

An intervening layer may also be chosen so that the bonding that it exhibits to the binder layer is greater than the bonding that it exhibits to carrier layer 110. This ensures that when carrier layer 110 is removed to provide the final retroreflective article 1, the intervening layer remains with the article in the general manner shown in FIG. 1. Still further (particular if an intervening layer is configured to remain in the final article 1 in the general manner shown in FIG. 1), the intervening layer may provide a protective function. For example, an intervening layer may minimize the ability of water to penetrate into an article so as to cause a metal reflective layer to possibly exhibit corrosion. Various compositions (e.g. polyurethane compositions and similar materials as mentioned earlier herein) of intervening layers have been found suitable for such purposes.

The above-described lamination process requires the providing of a pre-made binder layer 10 that comprises a pre-made reflective sheet 30′. In general, such an entity may be obtained by two approaches. A first approach is to form a binder layer 10 and then form, or otherwise dispose, a reflective sheet 30′ on the binder layer. A second approach is to form a reflective sheet 30′ and then form, or otherwise dispose, a binder layer 10 on the reflective sheet.

Regarding the first approach, a binder layer may be formed by any of the methods already referred to herein (e.g., by hot-melt coating and so on). The binder layer may then be maintained in a non-flowable state that is amenable to having a reflective sheet 30′ disposed thereon by any of various possible processes. In some embodiments, a reflective sheet 30′ may be disposed on a binder layer 10 by vapor-deposition, e.g. of a metal (such as aluminum or silver) or metal alloy onto a major surface of the binder layer. In some embodiments, a reflective sheet 30′ may be disposed on a binder layer 10 by coating, e.g. by LBL coating, or printing, e.g. by printing a silver ink or the like onto a major surface of the binder layer. (In any such vapor deposition, coating or printing method, a tie-layer or the like may be disposed on a major surface of the binder layer to enhance the adhesion of a subsequently disposed reflective layer.)

However, in some particularly convenient embodiments a reflective sheet 30′ may be pre-made e.g. as an entity that is then disposed on the binder layer e.g. by lamination (This will be a preliminary lamination process, used to produce a binder layer bearing a reflective sheet 30′ thereon, and is not to be confused with a subsequent, previously-described, process of laminating the reflective-sheet-bearing binder layer to a set of transparent microspheres.) Any such reflective sheet may take any form that is able to be laminated to the binder layer and to adhere thereto (and is able to release from any substrate (e.g. release liner) that the reflective sheet may have been initially formed on). Thus, for example, a reflective sheet may be provided in the form of a vapor-deposited, coated, or printed sheet on a release liner, and then is transferred to the binder layer. Since both of the items being laminated are typically locally planar (albeit possibly able to be handled in roll format), a preliminary lamination process typically will not cause the significant deformation of the binder layer and/or massive fracturing of the reflective sheet that occurs in the previously-described final lamination process of a reflective-layer-bearing binder layer to a set of transparent microspheres. However, a preliminary lamination process may cause the reflective sheet to exhibit fractures in such manner as to be characterized as a “contiguous” reflective layer as discussed earlier herein.

In some convenient embodiments a reflective layer that is laminated to a pre-made binder layer may take the form of a multilayer stack (comprising one or more of embrittlement layers, selective-bonding/release layers, and so on). The formation of multilayer stacks of this general type to facilitate lamination of a reflective layer to an entity is described in detail in U.S. Provisional Patent Application No. 62/739,506 and the resulting International Patent Application Publication WO2019/084295, both of which are incorporated by reference in their entirety herein. Those publications are concerned with the specific issue of performing “local” lamination of a reflective layer as discussed earlier herein. However, it will be appreciated that the compositions, arrangements and methods disclosed therein can also be used to laminate a reflective sheet 30′ to a binder layer 10 for the purposes disclosed herein. It will be further appreciated that the various arrangements disclosed therein can affect, for example, the particular order in which various layers (e.g. a reflecting layer 301, an embrittlement layer 302, and/or a selective-bonding layer 303, with reference to the previously-discussed FIG. 4) may be positioned in the final article.

A second general approach as mentioned above is to form a reflective sheet 30′ and then form, or otherwise dispose, a binder layer 10 on the reflective sheet. Such a reflective sheet will thus be pre-made in the absence of the binder layer, and thus should be made in such form as will allow the reflective sheet to be handled and to have a binder layer disposed thereon. In one simple embodiment, a reflective sheet may be a sheet of metal that is disposed (e.g. by vapor coating) onto a major surface of a release liner from which the metal will be releasable. A binder layer can then be disposed (e.g. by hot melt coating) on the opposing major surface of the reflective sheet to form the desired reflective-layer-bearing binder layer, from which the release liner can then be removed at a desired time.

In other embodiments a reflective sheet 30′ may be a multilayer stack of the general type referred to above. A binder layer can be disposed on such a reflective sheet in similar manner to that already described. It is noted that in some embodiments (e.g. when using hot-melt coating methods) a binder material may be solventless and may be disposed on a pre-made reflective sheet (or vice versa) using solventless methods. By solventless is meant that the binder material that is input to the process of combining the binder material with a reflective sheet to form a reflective-layer-bearing binder layer, includes less than 0.5 wt. % of volatile solvent (exclusive of water). In further embodiments, such a binder material may include less than 0.2 or 0.1 wt. % of volatile solvent.

In some embodiments a reflective sheet 30′ may be the actual layer that contacts the transparent microspheres (or an intervening layer present on the transparent microspheres) in the above-described lamination process. However, in some embodiments one or more additional layers may be disposed atop reflective sheet 30′ so that the additional layer (or the outermost of multiple additional layers) is the layer that actually contacts the transparent microspheres (or an intervening layer thereon). Such an additional layer might be e.g. a color layer, an optical retarder layer, an adhesion-promoting layer, or, in general, any suitably chosen layer, applied by any suitable method, e.g. coating printing, vapor-deposition and so on. In some embodiments (regardless of whether or not an additional layer is disposed atop reflective sheet 30′ prior to lamination) the outward surface of reflective sheet 30′ may be treated in any suitable manner, e.g. corona or plasma treated, flash-lamp treated, flame-treated, and so on, e.g. in order to enhance the ability of reflective sheet 30′ to adhere or be adhered to.

A binder layer as present in the form of a reflective-sheet-bearing binder layer, and particularly in a finished retroreflective article, will not be a flowable material at room temperature. By this is meant that the binder layer will exhibit a viscosity that is greater than 10⁸ cps. (In many instances, the viscosity will be so high as to not be measurable with any practical method). Such a binder layer can be heated to conditions (e.g. 90 degrees C.) that, together with an appropriate lamination pressure, cause the binder layer to soften to an extent to allow the above-described lamination to a set of transparent microspheres to be performed. In some arrangements, the binder layer may also need to be softened if a preliminary lamination is to be the method by which a reflective sheet is disposed on the binder layer. However, the conditions of such a preliminary lamination may not need to be as aggressive as for a lamination to a set of microspheres. In many embodiments, even at the high temperatures commensurate with lamination to a set of microspheres, a binder layer (while being able to deform sufficiently to conform to the transparent microspheres as described herein) may still exhibit such a high viscosity (e.g. greater than 10⁸ cps) that it cannot be considered to be a flowable material. In other words, at such temperatures such a binder layer may not be amenable to being coated onto a set of carrier-borne transparent microspheres in the conventional manner in which many binder layers are formed.

A binder layer as disclosed herein is a permanent component of a retroreflective article produced by lamination. Therefore, such a binder layer cannot be equated with, for example, a conformal substrate as is sometimes used as a temporary supporting substrate to assist in a lamination process and which does not remain as a permanent component of the laminated article (e.g. a conformal substrate of the general type described in International Patent Application Publication WO2019/084295).

In summary, the presently-disclosed methods rely on the use of a pre-made binder layer bearing a pre-made reflective sheet. The reflective-sheet-bearing side of the binder layer is contacted with a set of transparent microspheres so that the binder layer and the microspheres are laminated together. The microspheres may be e.g. positioned on a temporary carrier layer to facilitate this process. This process results in the pre-made reflective sheet being highly fractured. It will be clear from the discussions above (and from FIG. 3) that this process also results in the reflective sheet being highly deformed from an initially-made, e.g. essentially planar configuration. That is, the resulting set of reflective layers 30 will not all be in the same plane; rather, they will collectively exhibit a highly three-dimensional structure.

After a lamination process as disclosed herein is performed, the resulting article may be stored in any suitable format, and/or may be further processed as desired. In some convenient embodiments, a temporary carrier layer (whose original purpose was to present the set of microspheres in a format suitable for lamination) can be left in place (e.g. to protect the article) until such time as the carrier layer is removed. Strictly speaking, depending on the exact nature of the carrier layer, the article may not exhibit retrorereflective properties until the carrier layer is removed. However, for purposes of defining the concepts herein, an article comprising a carrier layer that is to be removed for actual use of the article in a retroreflective environment will be considered to be a retroreflective article. Any such article may be further processed e.g. to provide a transfer article as discussed in detail earlier herein.

Discussions herein have primarily concerned retroreflective articles in which areas 24 of microspheres 21 that are exposed (i.e., that protrude) forwardly of binder layer 10, are exposed to an ambient atmosphere (e.g., air) in the final retroreflective article as used. In other embodiments, the exposed areas 24 of microspheres 21 may be covered by, and/or reside within, a cover layer that is a permanent component of article 1. Such articles will be termed encapsulated-lens retroreflective articles. In such cases, the transparent microspheres may be chosen to comprise a refractive index that performs suitably in combination with the refractive index of the cover layer. In various embodiments, in an encapsulated-lens retroreflective article, the microspheres 21 may comprise a refractive index (e.g. obtained through the composition of the material of the microspheres, and/or through any kind of surface coating present thereon) that is at least 2.0, 2.2, 2.4, 2.6, or 2.8. In some embodiments, a cover layer of an encapsulated-lens retroreflective may comprise sublayers. In such cases, the refractive indices of the microspheres and the sublayers may be chosen in combination.

In some embodiments, such a cover layer may be a transparent layer. In other embodiments, the entirety, or selected regions, of a cover layer may be colored (e.g. may include one or more colorants) as desired. In some embodiments, a cover layer may take the form of a pre-existing film or sheet that is disposed (e.g. laminated) to at least selected areas of the front side of article 1. In other embodiments, a cover layer may be obtained by printing, coating or otherwise depositing a cover layer precursor onto at least selected areas of the front side of article 1, and then transforming the precursor into the cover layer.

As noted earlier herein, in some embodiments a color layer may perform wavelength-selective absorption of electromagnetic radiation at least somewhere in a range that includes visible light, infrared radiation, and ultraviolet radiation, by the use of a colorant that is disposed in the color layer. The term colorant broadly encompasses pigments and dyes. Conventionally, a pigment is considered to be a colorant that is generally insoluble in the material in which the colorant is present and a dye is considered to be a colorant that is generally soluble in the material in which the colorant is present. However, there may not always be a bright-line distinction as to whether a colorant behaves as a pigment or a dye when dispersed into a particular material. The term colorant thus embraces any such material regardless of whether, in a particular environment, it is considered to be a dye or a pigment. Suitable colorants are described and discussed in detail in the aforementioned U.S. Provisional Patent Application 62/675,020.

Transparent microspheres 21 as used in any article disclosed herein may be of any suitable type. The term “transparent” is generally used to refer to a body (e.g. a glass microsphere) or substrate that transmits at least 50% of electromagnetic radiation at a selected wavelength or within a selected range of wavelengths. In some embodiments, the transparent microspheres may transmit at least 75% of light in the visible light spectrum (e.g., from about 400 nm to about 700 nm); in some embodiments, at least about 80%; in some embodiments, at least about 85%; in some embodiments, at least about 90%; and in some embodiments, at least about 95%. In some embodiments, the transparent microspheres may transmit at least 50% of radiation at a selected wavelength (or range) in the near infrared spectrum (e.g. from 700 nm to about 1400 nm). In various embodiments, transparent microspheres may be made of e.g. inorganic glass, and/or may have a refractive index of e.g. from 1.7 to 2.0. (As noted earlier, in encapsulated-lens arrangements, the transparent microspheres may be chosen to have a higher refractive index as needed.) In various embodiments, the transparent microspheres may have an average diameter of at least 20, 30, 40, 50, 60, 70, or 80 microns. In further embodiments, the transparent microspheres may have an average diameter of at most 200, 180, 160, 140 120, 100, 80, or 60 microns. The vast majority (e.g. at least 90% by number) of the microspheres may be at least generally, substantially, or essentially spherical in shape. However, it will be understood that microspheres as produced in any real-life, large-scale process may comprise a small number of microspheres that exhibit slight deviations or irregularities in shape. Thus, the use of the term “microsphere” does not require that these items must be e.g. perfectly or exactly spherical in shape.

In various embodiments, in a retroreflective article 1, a microsphere 21 may be partially embedded in binder layer 10 so that on average, from 15, 20 or 30 percent of the diameter of the microsphere, to about 80, 70, 60 or 50 percent of the diameter of the microsphere, is embedded within the binder layer. In many embodiments, a microsphere may be partially embedded in the binder layer so that, on average, from 50 percent to 80 percent of the diameter of the microsphere is embedded within binder layer.

U.S. Pat. No. 10,054,724 and U.S. Patent Application Publication No. 2017/0293056, which are incorporated by reference in their entirety herein, discuss methods of characterizing retroreflectivity according to e.g. a coefficient of retroreflectivity (R_{A}). In various embodiments, at least selected areas of retroreflective articles as disclosed herein may exhibit a coefficient of retroreflectivity, measured (at 0.2 degrees observation angle and 5 degrees entrance angle) in accordance with the procedures outlined in these Publications, of at least 50, 100, 200, 250, 350, or 450 candela per lux per square meter. In some embodiments, the R_{A} may be highest when measured with a “head-on” entrance angle (e.g. 5 degrees). In other embodiments, the R_{A} may be highest when measured with a “glancing” entrance angle (e.g. 50 degrees, or even 88.76 degrees).

In various embodiments, retroreflective articles as disclosed herein may meet the photometric and physical performance requirements for retroreflective materials per ANSI/ISEA 107-2015 and/or ISO 20471:2013. In many embodiments, retroreflective articles as disclosed herein comply with the requirements for the minimum coefficient of retroreflection as shown in Table 5 of ANSI/ISEA 107-2015 (i.e., so called “32-angle” test). In many embodiments, retroreflective articles as disclosed herein may exhibit satisfactory, or excellent, wash durability. In some embodiments such wash durability may be manifested as high R_{A} retention (a ratio between R_{A} after wash and R_{A} before wash) after numerous (e.g. 25) wash cycles conducted according to ISO 6330 Method 2A, as outlined in U.S. Pat. No. 10,054,724. In some embodiments such wash durability may be manifested as high R_{A} retention after e.g. 10 wash cycles conducted according to ISO 6330 Method 6N.

In various embodiments, a retroreflective article as disclosed herein may exhibit a percent of R_{A} retention of at least 10%, 30%, 50%, or 75% after either of the above-listed washing methods is performed. In various embodiments, a retroreflective article as disclosed herein may exhibit any of these retroreflectivity-retention properties in combination with an initial R_{A} (before any washing) of at least 100 or 330 candela per lux per square meter, measured as noted above.

A retroreflective article as disclosed herein may be used for any desired purpose. In some embodiments the arrangements disclosed herein may provide a retroreflective article that provides visual color and/or an observable pattern in ambient light. In some embodiments the arrangements disclosed herein may provide a retroreflector that provides visual color and/or an observable pattern in retroreflected light. In some embodiments, both such functionalities may be present.

In some embodiments, a retroreflective article as disclosed herein may be configured for use in or with a system that performs e.g. machine vision, remote sensing, surveillance, or the like. Such a machine vision system may rely on, for example, one or more visible and/or near-infrared (IR) image acquisition systems (e.g. cameras) and/or radiation or illumination sources, along with any other hardware and software needed to operate the system. Thus in some embodiments, a retroreflective article as disclosed herein (whether or not it is mounted on a substrate) may be a component of, or work in concert with, a machine vision system of any desired type and configuration. Such a retroreflective article may, for example, be configured to be optically interrogated (whether by a visual-wavelength or near-infrared camera, e.g. at a distance of up to several meters, or even up to several hundred meters) regardless of the ambient light conditions. Thus in various embodiments, such a retroreflective article may comprise retroreflective elements configured to collectively exhibit any suitable image(s), code(s), pattern, or the like, that allow information borne by the article to be retrieved by a machine vision system. Exemplary machine vision systems, ways in which retroreflective articles can be configured for use in such systems, and ways in which retroreflective articles can be characterized with specific regard to their suitability for such systems, are disclosed in U.S. Provisional Patent Application No. 62/536,654, which is incorporated by reference in its entirety herein.

It will be appreciated that retroreflective elements comprising reflective layers as disclosed herein, can be used in any retroreflective article of any suitable design and for any suitable application. In particular, it is noted that the requirement of the presence of retroreflective elements comprising transparent microspheres (along with one or more color layers, reflective layers, etc.) does not preclude the presence, somewhere in the article, of other retroreflective elements (e.g. so-called cube-corner retroreflectors) that do not comprise transparent microspheres.

Although discussions herein have mainly concerned use of the herein-described retroreflective articles with garments and like items, it will be appreciated that these retroreflective articles can find use in any application, as mounted to, or present on or near, any suitable item or entity. Thus, for example, retroreflective articles as disclosed herein may find use in pavement marking tapes, road signage, vehicle marking or identification (e.g. license plates), or, in general, in reflective sheeting of any sort. In various embodiments, such articles and sheeting comprising such articles may present information (e.g. indicia), may provide an aesthetic appearance, or may serve a combination of both such purposes.

### Exemplary Embodiments and Combinations

A first exemplary embodiment is a retroreflective article comprising a binder layer and a plurality of retroreflective elements spaced over a length and breadth of a front side of the binder layer, at least some of the retroreflective elements each comprising a transparent microsphere partially embedded in the binder layer and a discontinuous binder-borne reflective layer that is positioned between the transparent microsphere and the binder layer and that is provided by a portion of a fractured binder-borne reflective sheet.

A 2^{nd} embodiment is the retroreflective article of embodiment 1 wherein for at least some of the retroreflective elements at least a portion of the binder layer is bonded directly, or bonded indirectly by way of at least one intervening layer, to a portion of the transparent microsphere, through a gap in the discontinuous binder-borne reflective layer.

Embodiment 3 is the retroreflective article of any of embodiments 1-2 wherein at least 80 percent of the retroreflective elements of the retroreflective article each comprise a discontinuous binder-borne reflective layer that is positioned between the transparent microsphere and the binder layer and that is provided by a portion of the fractured binder-borne reflective sheet.

Embodiment 4 is the retroreflective article of any of embodiments 1-3 wherein at least 50% of lateral areas between nearest-neighbor transparent microspheres have a discontinuous reflective layer present therein.

Embodiment 5 is the retroreflective article of any of embodiments 1-4 wherein at least some of the retroreflective elements comprise a polymeric intervening layer at least a portion of which is disposed between the transparent microsphere and the discontinuous binder-borne reflective layer.

Embodiment 6 is the retroreflective article of embodiment 5 wherein the polymeric intervening layer is an organic polymeric layer that is transparent.

Embodiment 7 is the retroreflective article of embodiment 5 wherein the polymeric intervening layer is an organic polymeric layer that comprises a colorant and/or is an optical retarder layer.

Embodiment 8 is the retroreflective article of any of embodiments 4-7 wherein each intervening layer is a portion of an intervening stratum that extends at least substantially continuously over the length and breadth of at least a retroreflective area of the retroreflective article.

Embodiment 9 is the retroreflective article of any of embodiments 1-8 wherein at least some of the discontinuous binder-borne reflective layers are in the form of a multilayer stack that includes at least one embrittlement layer.

Embodiment 10 is the retroreflective article of any of embodiments 1-9 wherein at least some of the discontinuous binder-borne reflective layers are in the form of a multilayer stack that includes a selective-bonding layer.

Embodiment 11 is the retroreflective article of any of embodiments 1-10 wherein at least some of the discontinuous binder-borne reflective layers comprise a metal reflecting layer.

Embodiment 12 is the retroreflective article of any of embodiments 1-11 wherein at least some of the discontinuous binder-borne reflective layers comprise a reflecting layer that is a dielectric reflecting layer comprising alternating high and low refractive index sublayers.

Embodiment 13 is the retroreflective article of any of embodiments 1-12 wherein at least some of the retroreflective elements each comprise a transparent microsphere with a transparent-microsphere-borne reflective layer disposed on at least some part of an embedded portion of the transparent microsphere so that the transparent-microsphere-borne reflective layer is between the transparent microsphere and the discontinuous binder-borne reflective layer.

Embodiment 14 is the retroreflective article of any of embodiments 1-13 wherein the binder layer comprises a colorant.

Embodiment 15 is the retroreflective article of any of embodiments 1-14 wherein the article exhibits a coefficient of retroreflectivity (R_{A}, measured at 0.2 degrees observation angle and 5 degrees entrance angle) after 25 wash cycles performed according to ISO 6330 Method 2A, or after 10 wash cycles performed according to ISO6330 Method 6N, that is at least 10% of an initial coefficient of retroreflectivity in the absence of being exposed to a wash cycle.

Embodiment 16 is the retroreflective article of any of embodiments 1-15 wherein the article meets the requirements for a minimum coefficient of retroreflection in a 32-angle test as shown in Table 5 of ANSI/ISEA 107-2015.

Embodiment 17 is a transfer article comprising the retroreflective article of any of embodiments 1-16 and a disposable carrier layer on which the retroreflective article is detachably disposed with at least some of the transparent microspheres in contact with the disposable carrier layer.

Embodiment 18 is a substrate comprising the retroreflective article of any of embodiments 1-16, wherein the binder layer of the retroreflective article is coupled to the substrate with at least some of the retroreflective elements of the retroreflective article facing away from the substrate.

Embodiment 19 is a method of making a retroreflective article by laminating a pre-made binder layer to a set of transparent microspheres, the method comprising: contacting a pre-made binder layer bearing a pre-made reflective sheet on a first surface thereof with a set of transparent microspheres so that the reflective sheet fractures to allow the binder layer to deform and to bond, directly or indirectly, to the transparent microspheres.

Embodiment 20 is the method of embodiment 19 wherein the transparent microspheres are provided on a carrier layer in which the transparent microspheres are detachably, partially embedded, and wherein the carrier layer is detached from the binder layer and from the transparent microspheres after the transparent microspheres are secured to the binder layer.

Embodiment 21 is the method of embodiment 20 wherein the transparent-microsphere-bearing carrier layer comprises a layer of polymeric material disposed at least on protruding portions of the transparent microspheres and wherein contacting the pre-made binder layer with the transparent microspheres causes the reflective sheet to fracture and allows at least some portions of the premade binder layer to contact, and bond to, the polymeric material.

Embodiment 22 is the method of any of embodiments 19-21 wherein the lamination is performed using first and second lamination tools.

Embodiment 23 is the method of embodiment 22 wherein at least one of the first and second lamination tools is heated to a temperature of at least 70 degrees C.

Embodiment 24 is the method of any of embodiments 22-23 wherein the first and second lamination tools are in the form of first and second backing rolls that are pressed together to provide a nip pressure of at least 200 pounds per linear inch or are in the form of first and second generally flat tools that are pressed together to provide a pressure of at least 30 pounds per square inch.

Embodiment 25 is the method of any of embodiments 19-24 wherein the pre-made reflective sheet is a multilayer structure comprising a reflecting layer and further comprising a layer of polymeric material that, after the lamination process is performed, is positioned between the reflecting layer and a transparent microsphere.

Embodiment 26 is the retroreflective article, transfer article or substrate of any of embodiments 1-18, made by the method of any of embodiments 19-25.

### EXAMPLES

### Test Methods

Retroreflectivity Measurement

Coefficients of reflection (R_{A} at an observation angle of 0.2° and an entrance angle of 5°) was reported in units of candelas per lux per square meter (candelas/lux/meter²), following the same test methods as described in U.S. Provisional Patent Application No. 62/739,506 and the resulting International Patent Application Publication No. WO2019/084295, both of which are incorporated by reference in their entirety herein. (Hereafter in the Examples, these documents are collectively referred to for brevity as “WO '295”).

In some cases, samples were evaluated in a “32-angle” test for the minimum coefficient of retroreflection for the 32 angle combinations as described in Table 5 of ANSI/ISEA 107-2015, which is often used in the evaluation of e.g. safety apparel.

In some cases, samples were evaluated in the presence of a circular polarizer, following the procedure as described in U.S. Provisional Patent Application Nos. 62/578,191 and 62/610,180 and the resulting International Patent Application Publication No. WO2019/082162, all of which are incorporated by reference in their entirety herein. % R_{A} retention with the circular polarizer was reported.

Color Measurement

Color coordinates in ambient light conditions (Y, x, y for fluorescent yellow color, or L*, a*, b* for other colors such as white) followed the same test methods as described in WO '295.

Wash Durability Test

Test samples were prepared by sewing a 50 millimeters (mm) by 150 mm rectangle appliques of the indicated fabric articles onto a piece of polyester/cotton 85/15 fluorescent orange fabric having a weight of 270 grams per meter squared. The samples were then washed for either 10 cycles according to ISO 6330 Method 6N, or 25 cycles according to ISO 6330 Method 2A. R_{A} was measured after indicated wash protocols. A sample is deemed as “wash durable” under the indicated protocol if the percent retention of R_{A} (calculated as a ratio between R_{A} after wash and R_{A} before wash) after indicated wash durability test is greater than or equal to 10%.

TABLE 1
Materials

| Designation | Description |
|---|---|
| EHA | 2-Ethylhexyl acrylate, available from BASF, Florham Park, NJ |
| IBOA | Iso-Bornyl acrylate, available from San Esters, New York, NY |
| AA | Acrylic acid available from BASF, Florham Park, NJ |
| LA2330 | An acrylic block copolymer, under the trade name of KURARITY LA 2330 |
| | available from Kuraray, Houston, TX |
| TMPTA | Trimethylolpropane triacrylate, available from Allnex, Alpharetta, GA |
| Irg 819 | A photo initiator, under the trade name of IRGACURE 819 available from |
| | BASF, Florham Park, NJ |
| GN4188/EHA | A monofunctional urethane acrylate in EHA, under the trade name of |
| | GENOMER 4188/EHA available from Rahn USA Corporation, Aurora, IL |
| GT-17 | A fluorescent lime-yellow pigment power, under the trade name of GT-17 |
| | SATURN YELLOW available from Day Glo Color Corporation, Cleveland, |
| | OH |
| White Pigment | A white pigment powder, under the trade name of Dupont Ti-Pure R900 |
| | available from The Chemours Company, Wilmington, DE |
| Acrylate-1 | An acrylate liquid based on tricyclodecane dimethanol diacrylate, under the |
| | trade name of SARTOMER SR833 available from Sartomer USA, Exton, PA |
| Kraton D1119 | Copolymer based on styrene and isoprene with a styrene content of 22%, under |
| | the trade name of Kraton D1119 available from Kraton Corporation, Houston, |
| | TX |
| Westrez 5206 | Maleated glycerol ester resin based tackifier, available as Westerz 5206 from |
| | Ingevity, North Charleston, SC |
| Polyester Fabric | A white 100% polyester fabric, available from Milliken & Company, |
| | Spartanburg, SC |
| Resinall 476 | Rosin ester with medium dibasic acid levels based tackifier, available under the |
| | trade name of Resinall 476 from Resinall Corp, Severn, NC |
| Vector D4411 | Copolymer based on styrene and isoprene with a styrene content of 44%, |
| | available under the trade name of Vector D4411A, TSRC, Dexco Polymers |
| | LLP, Taipei, Taiwan |
| Temporary Carrier | Polyethylene coated paper film, available from Felix Schoeller Group, |
| | Osnabruck, Germany |

### Preliminary Articles and Methods of Making

Disposing transparent microspheres on a Temporary Carrier followed the same general process as outlined in the “Method for Making Temporary Bead Carrier containing Glass Microspheres” section of WO '295. The resulting article is referred to as a Temporary Bead Carrier (noting that the term “bead” denotes a transparent microsphere).

Disposing an organic polymeric intervening layer on a Temporary Bead Carrier, if performed, followed the same general process as described in the first paragraph of Working Example 2.3.1.D (Part D) of WO '295. The resulting article is referred to as a Polymer Coated Bead Carrier.

Disposing an Ag (metallic silver) mirror on a Polymer Coated Bead Carrier, if performed, followed the same general process as described in Working Example 2.4.1 part B of WO '295. The resulting article is referred to as Locally-Laminated Ag Bead Carrier.

### Working Example 1

A clear adhesive composition with 39.9 parts by weight (%) of EHA, 30.0% IBOA, 10.0% AA, 20.0% LA2330, 0.1% TMPTA, and 0.8% Irg 819 was mixed in a brown glass jar and rolled overnight with a jar roller. The clear adhesive composition was coated onto a 3M 200MP polycoated Kraft release liner using a notch bar coating station with a gap setting of 102 um. The resulting combination was exposed to a total UV-A energy of 2400 milliJoules/square centimeter (mJ/cm²) from the coating side in a nitrogen-inerted environment using a plurality of fluorescent lamps having a peak emission wavelength of 365 nm. The total UV-A energy was determined using a POWERMAP radiometer equipped with lower power sensing head (available from EIT Incorporated, Sterling, Va.). The radiometer web speed and energy were then used to calculate the total exposure energy at the web speed used during curing of the adhesive composition. The resulting article is referred to as Adhesive Film-1. (The adhesive layer of this article could be used as an aforementioned bonding layer 120, for example.)

A fluorescent yellow binder composition with 44.2% EHA, 16.4% IBOA, 9.3% AA, 23.4% GN4188/EHA, 0.09% TMPTA, 0.75% Irg 819, and 6.5% GT-17 was mixed in a brown glass jar and rolled overnight with a jar roller. The fluorescent yellow binder composition was coated onto the adhesive side of Adhesive Film-1 using a notch bar coating station with a gap setting of 51 um. The resulting combination was exposed to a total UV-A energy of 2400 mJ/cm² from the coating side in a nitrogen-inerted environment using a plurality of fluorescent lamps having a peak emission wavelength of 365 nm. The resulting article, comprising a thus-formed fluorescent yellow binder layer, is referred to as Binder Film-1.

A sheet of Temporary Carrier (comprising a layer of polyethylene atop a layer of paper, and not comprising any beads) was vacuum coated with approximately 170 nm thick aluminum(Al) mirror. This article was then contacted with, and laminated to, the exposed binder layer surface of Binder Film-1 at 60° C. and 0.2 meter per minute (m/min) with a heated desktop roll laminator (such as Linea DH-360 Roll Laminator available from Vivid laminating Technology Ltd. UK). The Temporary Carrier was then separated from the binder layer to provide an intermediate laminate article.

After this, the exposed Al mirror side of the intermediate laminate article was contacted with, and laminated to, a Polymer Coated Bead Carrier (that comprised an intervening layer of organic polymeric material, as noted above, but did not comprise any mirror layer) at 90° C. and 0.2 m/min with a heated desktop roll laminator The resulting laminate was then pressed down with an edge of a metal plate. The lamination process resulted in the Al mirror fracturing and the binder layer bonding to the intervening layer and the transparent microspheres in the general manner disclosed herein.

Finally, the adhesive layer of this article was exposed by removal of the polycoated Kraft release liner; the adhesive layer was then used to laminate the article to Polyester Fabric at 60° C. and 0.2 m/min with a heated desktop roll laminator. Temporary Carrier was then separated and removed to provide the resulting Working Example 1 retroreflective article.

Working Example 1 was a gray colored retroreflective material with R_{A} of 472 and met the requirements for the minimum coefficient of retroreflection for the 32-angle combination as shown in Table 5 of ANSI/ISEA 107-2015. Working Example 1 had good wash performance, with 42% retention of R_{A} after 10 wash cycles according to ISO 6330 Method 6N.

### Working Example 2

Binder Film-1 was prepared as described in Working Example 1. The exposed major surface of the binder layer of Binder Film-1 was vacuum coated with approximately 170 nm thick Al mirror. After this, the exposed Al mirror side of the article was contacted with, and laminated to, a Polymer Coated Bead Carrier at 90° C. and 0.2 m/min with a heated desktop roll laminator. The resulting laminate was then pressed down with an edge of a metal plate. The lamination process resulted in the Al mirror fracturing and the binder layer bonding to the intervening layer and the transparent microspheres in the general manner disclosed herein.

Finally, the adhesive layer of this article was exposed by removal of the polycoated Kraft release liner; the adhesive layer was then used to laminate the article to Polyester Fabric at 60° C. and 0.2 m/min with a heated desktop roll laminator Temporary Carrier was then separated and removed to provide the resulting Working Example 2 retroreflective article.

Working Example 2 was a gray colored retroreflective material with R_{A} of 313.

### Working Example 3

Preparation of Reflective Sheet Comprising Multiple Layers

A multi-layer transfer Al mirror film was prepared on a roll to roll vacuum coater similar to the coater described in U.S. Pat. No. 9,034,459 with the addition of a second evaporator and curing system located between the plasma pretreatment station and the first sputtering system, and using evaporators as described in U.S. Pat. No. 8,658,248.

This coater was outfitted with a substrate in the form of a 305 meters (m) length roll of 0.05 mm thick, 35.6 centimeters (cm) wide polyethylene terephthalate (PET) film manufactured by 3M Company. The substrate was prepared for coating by subjecting it to a nitrogen plasma treatment to improve the adhesion of the metallic layer. The film was treated with a nitrogen plasma operating at 120 watts (W) using a titanium cathode, using a web speed of 9.8 m/min and maintaining the backside of the film in contact with a coating drum chilled to −10° C.

On this prepared PET substrate, a release layer of SiAl was deposited in-line with the previous plasma treatment step. The cathode had a Si(90%)/Al(10%) target obtained from Soleras Advanced Coatings US, of Biddeford, Me. A conventional AC sputtering process employing Ar gas and operated at 24 kilowatts (kW) of power was used to deposit a 37 nm thick layer of SiAl alloy onto the substrate. The resulting SiAl coated PET substrate is a sacrificial mirror substrate.

A layer of Acrylate-1 was deposited in-line on top of the SiAl layer of the sacrificial mirror substrate. The acrylate layer was applied by ultrasonic atomization and flash evaporation to make a coating width of 31.8 cm. The flow rate of this mixture into the atomizer was 1.33 millimeters per minute (ml/min) to achieve a 375 nm layer, the gas flow rate was 60 standard cubic centimeters per minute (sccm), and the evaporator temperature was 260° C. Once condensed onto the SiAl layer, this monomeric coating was cured immediately with an electron beam curing gun operating at 7.0 kV and 10.0 milliamps (mA) to form an acrylate layer (which served as a selective-bonding layer).

On this acrylate layer, an inorganic oxide layer (which served as an embrittlement layer) was applied. This oxide material was laid down by an AC reactive sputter deposition process employing a 40 kilohertz (kHz) AC power supply. The cathode had a Si(90%)/Al(10%) rotary target obtained from Soleras Advanced Coatings US, of Biddeford, Me. The voltage for the cathode during sputtering was controlled by a feed-back control loop that monitored the voltage and controlled the oxygen flow such that the voltage would remain high and not crash the target voltage. The system was operated at 16 kW of power and 9.8 m/min to deposit a 12 nm thick layer of silicon aluminum oxide (SiAlOx) onto the acrylate layer on the SiAl layer.

On this inorganic oxide layer, a reflective layer of Al was applied using a cathode Al target that was obtained from ACI Alloys of San Jose, Calif. A pair of cathodes were used. This Al metal mirror layer was deposited by a conventional DC sputtering process employing Ar gas, operated at 3 kW of power per cathode, and at a 3.7 m/min line speed to deposit a 90 nm thick layer of Al. The resulting article is referred to as Transferable Mirror Film-1 that included a 375 nm acrylate layer, a 12 nm SiAlOₓ layer, and a 90 nm Al reflective layer on top of the sacrificial mirror substrate.

Preparation of Binder Layer

A clear binder composition with 43.65% EHA, 23.75% IBOA, 10.00% AA, 12.50% GN4188/EHA, 0.10% TMPTA, and 0.80% Irg 819 was mixed in a brown glass jar and rolled overnight with a jar roller. The clear binder composition was coated onto the transfer stack side of the Transferable Mirror Film-1 using a notch bar coating station with a gap setting of 102 um. The resulting combination was exposed to a total UV-A energy of 2400 mJ/cm² from the coating side in a nitrogen-inerted environment using a plurality of fluorescent lamps having a peak emission wavelength of 365 nm. The resulting article is referred to as Binder Film-2.

The binder layer side of Binder Film-2 was then pressed to Bemis 5256 polyester-based thermoplastic adhesive (available from Bemis Associates Inc., Shirley, Mass.) at 135° C. and 40 pounds per square inch (PSI) for 10 seconds, using a Hix N-800 clamshell laminator After removal of the release liner from Bemis 5256 adhesive, the adhesive side of the laminate was pressed to Polyester Fabric at 135° C. and 40 PSI for 10 seconds, using a Hix N-800 clamshell laminator.

After this, the sacrificial of Transferable Mirror Film-1 were removed. That is, the PET substrate was separated from the article, with the separation occurring at the interface between the Acrylate-1 selective-bonding layer and the SiAl release layer so that the SiAl release layer was removed with the PET substrate. This produced an intermediate article comprising a binder layer bearing a pre-made multi-layer reflective sheet comprising (in order, starting closest to the binder layer) an Al reflecting layer, an SiAlOx embrittlement layer, and an Acrylate-1 selective-bonding layer.

The reflective side of the intermediate article was then laminated to Polymer Coated Bead Carrier at 90° C. and 0.2 m/min with a heated desktop roll laminator. The laminate was then pressed down with an edge of a metal plate. The lamination process resulted in the multilayer reflective sheet fracturing and the binder layer bonding to the intervening layer and the transparent microspheres in the general manner disclosed herein.

Temporary Carrier was then separated and removed to provide the resulting Working Example 3 retroreflective article.

Working Example 3 was a gray colored retroreflective material with R_{A} of 492 and met the requirements for the minimum coefficient of retroreflection for the 32 angle combinations as shown in Table 5 of ANSI/ISEA 107-2015. Working Example 3 had good wash performance, with 80% retention of R_{A} after 25 wash cycles according to ISO 6330 Method 2A.

### Working Example 4

A multi-layer transfer Ag mirror film was prepared following a similar procedure as described for Working Example 2.4.1 Part A in WO'295, with a transfer stack that included a 90 nm Acrylate-1 selective-bonding layer, a 90 nm Ag reflective layer, and a 6 nm silicon aluminum oxide (SiAlOₓ) embrittlement layer on top of a sacrificial mirror substrate. The resulting article (the sacrificial mirror substrate bearing the above-recited transfer stack) is referred to as Transferable Mirror Film-2.

A clear binder layer was prepared by mixing 60% of Kraton D1119 and 40% of Westerz 5206 in a twin-screw extruder at 182° C. for 3 minutes (min). The mixed composition was then extruded with a contact die at approximately 101 um in coating thickness onto a virgin PET release liner and cooled. The resulting article is referred to as Binder Film-3.

The binder layer side of Binder Film-3 was then laminated to the transfer stack side of Transferable Mirror Film-2 by a hand roller. After removal of the sacrificial mirror substrate of the Transferable Mirror Film-2, the reflective side of the laminate was then laminated to Polymer Coated Bead Carrier with 500 pounds per linear inch (PLI, approximately equivalent to 87.5 kilo Newton per meter) of lamination force at 1.3 millimeters per second (mm/s). During the lamination, the virgin PET release liner side of the laminate was backed by a 12 inch (0.30 m) diameter silicone rubber sleeve with a 68A hardness heated at 82° C., and Temporary Carrier side of the laminate was backed by a 12 inch diameter smooth-faced steel roll set at ambient temperature. The lamination process resulted in the multilayer reflective sheet fracturing and the binder layer bonding to the intervening layer and the transparent microspheres in the general manner disclosed herein. After removal of the virgin PET release liner, the binder layer side of the resulting laminate was pressed to Polyester Fabric at 148° C. and 40 PSI for 15 seconds, using a Hix N-800 clamshell laminator. Working Example 4 retroreflective article was prepared by removal of Temporary Carrier from the above laminate.

Working Example 4 was a gray colored retroreflective material with R_{A} of 622, L* of 68.6, a* of −1.2, and b* of 4.8. Working Example 4 met the requirements for the minimum coefficient of retroreflection for the 32 angle combinations as shown in Table 5 of ANSI/ISEA 107-2015.

### Working Example 5

A multi-layer transfer visible dielectric mirror film was prepared as described for Transfer Stack R3518-3 in U.S. Provisional Patent Application No. 62/838,580, with a transfer stack that included a 300 nm acrylate selective-bonding layer, a 58 nm NbOₓ layer, a 91 nm acrylate layer, and a 58 nm NbOₓ layer on top of a sacrificial mirror substrate. The resulting article is referred to as Transferable Mirror Film-3.

A fluorescent yellow binder layer was prepared by mixing 59.5% of Kraton D1119, 25.5% of Resinall 476, and 15.0% GT-17 in a twin-screw extruder at 182° C. min for 3 min. The mixed composition was then extruded with a contact die at approximately 101 um in coating thickness onto a first virgin PET release liner. A white adhesive layer was prepared by mixing 20.0% of Kraton D1119, 11.5% of Resinall 476, 58.5% Vector D4411, and 15.0% White Pigment in a twin-screw extruder at 182° C. min for 3 min. The mixed composition was then extruded with a contact die at approximately 101 um in coating thickness onto a second virgin PET release liner. The fluorescent yellow binder layer and the white adhesive layer was first laminated by a hand roller. After removal of the second virgin PET release liner, the white adhesive side of the laminate was then laminated to Polyester fabric by a hand roller. The resulting article after removal of the first virgin PET release liner is referred to as Binder Film-4.

The fluorescent yellow binder side of Binder Film-4 was laminated to the transfer stack side of Transferable Mirror Film-3 by a hand roller. After removal of the of the sacrificial mirror substrate of the Transferable Mirror Film-3, the transfer stack side of the laminate was pressed to Polymer Coated Bead Carrier at 177° C. and 40 PSI for 20 seconds twice, using a Hix N-800 clamshell laminator The lamination process resulted in the multilayer reflective sheet fracturing and the binder layer bonding to the intervening layer and the transparent microspheres in the general manner disclosed herein. Working Example 5 retroreflective article was prepared by removal of Temporary Carrier from the above laminate Working Example 5 was a fluorescent yellow colored retroreflective material with R_{A} of 200.

### Working Example 6

Transferable Mirror Film-1 was prepared as described in Working Example 3. Binder Film-1 was prepared as described in Working Example 1. The binder side of Binder Film-1 was laminated to the transfer stack side of Transferable Mirror Film-1 at 60° C. and 0.2 m/min with a heated desktop roll laminator. After removal of the sacrificial mirror substrate of the Transferable Mirror Film-1, the transfer stack side of the laminate was coated with a conformal retarder layer, following the same procedure as described in “Preparation of First Laminate with Conformal Retarder” in U.S. Provisional Patent Application Nos. 62/578,191 and 62/610,180 and the resulting International Patent Application Publication No. WO2019/082162.

The side of a Polymer Coated Bead Carrier bearing the organic polymer layer was corona treated and laminated to the conformal retarder side of the above laminate at 90° C. and 0.2 m/min with a heated desktop roll laminator. The laminate was then pressed down with an edge of a metal plate. The lamination process resulted in the multilayer reflective sheet fracturing and the binder layer bonding to the intervening layer and the transparent microspheres in the general manner disclosed herein. Finally, the adhesive side of the laminate was exposed by removal of the polycoated Kraft release liner and was then laminated to a polyimide fabric at 104° C. and 0.8 m/min with a heated desktop roll laminator. Working Example 6 retroreflective article was prepared by removal of Temporary Carrier from the above laminate Working Example 6 was a gray colored retroreflective material with R_{A} of 263, L* of 66.4, a* of −1.7, and b* of 1.1. Working Example 6 gave 11% R_{A} retention in the presence of the circular polarizer.

### Working Example 7

A multi-layer transfer visible dielectric mirror film was prepared following a similar procedure as described for Transfer Stack R3512 in U.S. Provisional Patent Application No. 62/838,580, with a transfer stack that included a 70 nm acrylate selective-bonding layer, a 65 nm NbOₓ layer, a 90 nm acrylate layer, a 65 nm NbOₓ layer, a 90 nm acrylate layer, and a 65 nm NbOₓ layer on top of a sacrificial mirror substrate. The resulting article is referred to as Transferable Mirror Film-4.

A fluorescent yellow binder layer was prepared by mixing 51.0% of Kraton D1119, 34.0% of Westrez 5206, and 15.0% GT-17 in a twin-screw extruder at 182° C. min for 3 min. The mixed composition was then extruded with a contact die at approximately 101 um in coating thickness onto a first virgin PET release liner. A white adhesive layer was prepared by mixing 51.0% of Kraton D1119, 34.0% of Westrez 5206, and 15.0% White Pigment in a twin-screw extruder at 182° C. min for 3 min. The mixed composition was then extruded with a contact die at approximately 101 um in coating thickness onto a second virgin PET release liner. The fluorescent yellow binder layer and the white adhesive layer was first laminated by a hand roller. After removal of the second virgin PET release liner, the white adhesive side of the laminate was then laminated to Polyester fabric by a hand roller. The resulting article after removal of the first virgin PET release liner is referred to as Binder Film-5.

The fluorescent yellow binder side of Binder Film-5 was laminated to the transfer stack side of Transferable Mirror Film-4 by a hand roller. After removal of the sacrificial mirror substrate of the Transferable Mirror Film-4, the transfer stack side of the laminate was laminated to a Locally-Laminated Ag Bead Carrier at 500 PLI of lamination force and 1.3 mm/s. During the lamination, the fabric side of the laminate was backed by a 12 inch (0.30 m) diameter silicone rubber sleeve with a 68A hardness heated at 116° C., and Temporary Carrier side of the laminate was backed by a 12 inch diameter smooth-faced steel roll set at ambient temperature. The lamination process resulted in the multilayer reflective sheet fracturing and the binder layer bonding to the locally-laminated Ag reflective layer, the intervening layer, and the transparent microspheres in the general manner disclosed herein. Working Example 7 retroreflective article was prepared by removal of Temporary Carrier from the above laminate.

Working Example 7 was a fluorescent yellow colored retroreflective material with R_{A} of 441, Y of 74.9, x of 0.3895, y of 0.4837. Working Example 7 met the requirements for the minimum coefficient of retroreflection for the 32 angle combinations as shown in Table 5 of ANSI/ISEA 107-2015. Working Example 7 had good wash performance, with 30% retention of R_{A} after 10 wash cycles according to ISO 6330 Method 6N.

### Working Example 8

Transfer Mirror Film-2 and Binder Film-3 were prepared as described in Working Example 4.

The binder side of Binder Film-3 was then laminated to the transfer stack side of Transferable Mirror Film-2 by a hand roller. After removal of the sacrificial mirror substrate, the reflective side of the laminate was then laminated to a Temporary Bead Carrier (not comprising an intervening organic polymeric layer) with 500 PLI of lamination force at 1.3 mm/s. During the lamination, the virgin PET release liner side of the laminate was backed by a 12 inch diameter silicone rubber sleeve with a 68A hardness heated at 82° C., and the Temporary Carrier side of the laminate was backed by a 12 inch diameter smooth-faced steel roll set at ambient temperature. After removal of the virgin PET release liner, the binder side of the resulting laminate was pressed to Polyester Fabric at 148° C. and 40 PSI for 15 seconds, using a Hix N-800 clamshell laminator. The lamination process resulted in the multilayer reflective sheet fracturing and the binder layer bonding to the transparent microspheres in the general manner disclosed herein. Working Example 8 retroreflective article was prepared by removal of Temporary Carrier from the above laminate. Working Example 8 was a gray colored retroreflective material with R_{A} of 258, L* of 78.3, a* of −1.2, and b* of 5.5.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein, this specification as written will control.

What is claimed is:

1. A retroreflective article comprising:
a binder layer; and,
a plurality of retroreflective elements spaced over a length and breadth of a front side of the binder layer, at least some of the retroreflective elements each comprising a transparent microsphere partially embedded in the binder layer and a discontinuous binder-borne reflective layer that is positioned between the transparent microsphere and the binder layer and that is provided by a portion of a fractured binder-borne reflective sheet.

2. The retroreflective article of claim 1 wherein for at least some of the retroreflective elements at least a portion of the binder layer is bonded directly, or bonded indirectly by way of at least one intervening layer, to a portion of the transparent microsphere, through a gap in the discontinuous binder-borne reflective layer.

3. The retroreflective article of claim 1 wherein at least 80 percent of the retroreflective elements of the retroreflective article each comprise a discontinuous binder-borne reflective layer that is positioned between the transparent microsphere and the binder layer and that is provided by a portion of the fractured binder-borne reflective sheet.

4. The retroreflective article of claim 1 wherein at least 50% of lateral areas between nearest-neighbor transparent microspheres have a discontinuous reflective layer present therein.

5. The retroreflective article of claim 1 wherein at least some of the retroreflective elements comprise a polymeric intervening layer at least a portion of which is disposed between the transparent microsphere and the discontinuous binder-borne reflective layer.

6. The retroreflective article of claim 5 wherein the polymeric intervening layer is an organic polymeric layer that is transparent.

7. The retroreflective article of claim 5 wherein the polymeric intervening layer is an organic polymeric layer that comprises a colorant and/or is an optical retarder layer.

8. The retroreflective article of claim 4 wherein each intervening layer is a portion of an intervening stratum that extends at least substantially continuously over the length and breadth of at least a retroreflective area of the retroreflective article.

9. The retroreflective article of claim 1 wherein at least some of the discontinuous binder-borne reflective layers are in the form of a multilayer stack that includes at least one embrittlement layer.

10. The retroreflective article of claim 1 wherein at least some of the discontinuous binder-borne reflective layers are in the form of a multilayer stack that includes a selective-bonding layer.

11. The retroreflective article of claim 1 wherein at least some of the discontinuous binder-borne reflective layers comprise a metal reflecting layer.

12. The retroreflective article of claim 1 wherein at least some of the discontinuous binder-borne reflective layers comprise a reflecting layer that is a dielectric reflecting layer comprising alternating high and low refractive index sublayers.

13. The retroreflective article of claim 1 wherein at least some of the retroreflective elements each comprise a transparent microsphere with a transparent-microsphere-borne reflective layer disposed on at least some part of an embedded portion of the transparent microsphere so that the transparent-microsphere-borne reflective layer is between the transparent microsphere and the discontinuous binder-borne reflective layer.

14. The retroreflective article of claim 1 wherein the binder layer comprises a colorant.

15. The retroreflective article of claim 1 wherein the article exhibits a coefficient of retroreflectivity (R_{A}, measured at 0.2 degrees observation angle and 5 degrees entrance angle) after 25 wash cycles performed according to ISO 6330 Method 2A, or after 10 wash cycles performed according to ISO6330 Method 6N, that is at least 10% of an initial coefficient of retroreflectivity in the absence of being exposed to a wash cycle.

16. The retroreflective article of claim 1 wherein the article meets the requirements for a minimum coefficient of retroreflection in a 32-angle test as shown in Table 5 of ANSI/ISEA 107-2015.

17. A transfer article comprising the retroreflective article of claim 1 and a disposable carrier layer on which the retroreflective article is detachably disposed with at least some of the transparent microspheres in contact with the disposable carrier layer.

18. A substrate comprising the retroreflective article of claim 1, wherein the binder layer of the retroreflective article is coupled to the substrate with at least some of the retroreflective elements of the retroreflective article facing away from the substrate.

19. A method of making a retroreflective article by laminating a pre-made binder layer to a set of transparent microspheres, the method comprising:
contacting a pre-made binder layer bearing a pre-made reflective sheet on a first surface thereof with a set of transparent microspheres so that the reflective sheet fractures to allow the binder layer to deform and to bond, directly or indirectly, to the transparent microspheres.

20. The method of claim 19 wherein the transparent microspheres are provided on a carrier layer in which the transparent microspheres are detachably, partially embedded, and wherein the carrier layer is detached from the binder layer and from the transparent microspheres after the transparent microspheres are secured to the binder layer.

21. The method of claim 20 wherein the transparent-microsphere-bearing carrier layer comprises a layer of polymeric material disposed at least on protruding portions of the transparent microspheres and wherein contacting the pre-made binder layer with the transparent microspheres causes the reflective sheet to fracture and allows at least some portions of the premade binder layer to contact, and bond to, the polymeric material.

22. The method of claim 19 wherein the lamination is performed using first and second lamination tools.

23. The method of claim 22 wherein at least one of the first and second lamination tools is heated to a temperature of at least 70 degrees C.

24. The method of claim 22 wherein the first and second lamination tools are in the form of first and second backing rolls that are pressed together to provide a nip pressure of at least 200 pounds per linear inch or are in the form of first and second generally flat tools that are pressed together to provide a pressure of at least 30 pounds per square inch.

25. The method of claim 19 wherein the pre-made reflective sheet is a multilayer structure comprising a reflecting layer and further comprising a layer of polymeric material that, after the lamination process is performed, is positioned between the reflecting layer and a transparent microsphere.
